(19) United States
(12) Patent Application Publication
(10) Pub. No.: US 2018/0270536 A1
(43) Pub. Date: Sep. 20, 2018

(54) METHODS, SYSTEMS AND APPARATUS FOR PLAYING BACK POWER SAVING MEDIA CONTENT

(71) Applicant: THOMSON Licensing, Issy-les-Moulineaux (FR)

(72) Inventors: Chad Andrew LEFEVRE, INDIANAPOLIS, IN (US); Thomas Edward HORLANDER, INDIANAPOLIS, IN (US); Mark Francis RUMREICH, INDIANAPOLIS, IN (US)

(21) Appl. No.: 15/760,194

(22) PCT Filed: Sep. 15, 2016
(86) PCT No.: PCT/US2016/051809

§ 371 Date: Mar. 14, 2018

Related U.S. Application Data
(63) Continuation of application No. PCT/US2016/047379, filed on Aug. 17, 2016.
(60) Provisional application No. 62/372,475, filed on Aug. 9, 2016.
(60) Provisional application No. 62/372,470, filed on Aug. 9, 2016.
(60) Provisional application No. 62/218,679, filed on Sep. 15, 2015.

(51) Int. Cl. H04N 21/462; H04N 21/434; H04N 21/44

(52) U.S. Cl. CPC H04N 21/4621; H04N 21/44004; H04N 21/44008; H04N 21/4345

(57) ABSTRACT

A method for adjusting power consumption of playing back a media content is presented. The method comprises receiving media content having first and second media segments; playing back the first media segment with a first number of frames different from a second number of frames in the first media segment; and playing back the second media segment, wherein the first number is determined according to average power of the first media segment and average power of the media content.

### REFERENCE TO RELATED PROVISIONAL APPLICATION

This application claims priority from U.S. Provisional Application No. 62/218,679, entitled “METHODS, SYSTEMS AND APPARATUS FOR PROVIDING POWER SAVING MEDIA CONTENT,” filed on Sep. 15, 2015, U.S. Provisional Application No. 62/372,470, entitled “METHODS, SYSTEMS AND APPARATUS FOR PROVIDING POWER SAVING MEDIA CONTENT,” filed on Aug. 9, 2016, and U.S. Provisional Application No. 62/372,475, entitled “METHODS, SYSTEMS AND APPARATUS FOR PROVIDING POWER SAVING MEDIA CONTENT,” filed on Aug. 9, 2016, and International Patent Application No. PCT/US2016/047379, entitled “METHOD AND APPARATUS FOR PROVIDING POWER SAVING MEDIA CONTENT, filed on Aug. 17, 2016, the contents of which are hereby incorporated by reference in its entirety.

### TECHNICAL FIELD

Embodiments of the present principles generally relate to methods, systems and apparatus for video content processing. In particular, the present principles relate to playing back energy saving contents and metadata for conserving power consumption while viewing the contents.

### BACKGROUND

Many modern televisions and display devices display content of varying brightness and dynamically vary power. Under normal viewing conditions, typical LCD television receivers may consume 150 watts of power. About half of the power consumption is due to the backlighting of a display. Many backlights are zone dimmable, allowing contrast enhancement by dimming the backlight in dark scene areas. When zone dimmable backlighting is used, the power consumed by a display depends on zone brightness. For example, an all-white scene might consume 150 watts, an all-black scene 75 watts, an all-gray scene 110 watt. A scene with the left side of the screen black and the right side white might consume 110 watts.

Many TVs today also provide an energy saving mode that reduces the overall backlight brightness regardless of the scene content. However, these devices do not save power depending on program content, anticipated future scenes, or knowledge of power utility conditions. They are therefore limited in their abilities to reduce power consumption.

### BRIEF SUMMARY OF THE DRAWINGS

The features and advantages of the present principles may be apparent from the detailed description below when taken in conjunction with the figures described below:

FIG. 1 illustrates a schematic diagram of a system in accordance with present principles.

FIG. 2A illustrates a schematic diagram of an apparatus in accordance with present principles.

FIG. 2B illustrates a schematic diagram of an apparatus in accordance with present principles.

FIG. 3 illustrates a schematic diagram of a system in accordance with present principles.

FIG. 4A illustrates a flow diagram of a method in accordance with present principles.

FIG. 4B illustrates a flow diagram of a method in accordance with present principles.

FIG. 5 illustrates a of a plot diagram illustrating modified playout time determination(s) in accordance with present principles.

FIG. 6 illustrates a diagram of a transfer function in accordance with present principles.

FIG. 7 illustrates a process performed by a user device when the user selects the option of performing power saving function for all versions of a received media content in accordance with present principles.

FIG. 8 illustrates an example of a received completely sped-up media content.

FIG. 9 illustrates duration changes for segments included in the completely sped-up media content in FIG. 8 with a constraint on power consumption per time unit after considering power saving in accordance with present principles.

FIG. 10 illustrates duration changes for segments included in the completely sped-up media content in FIG. 8 with a constraint on total power consumption after considering power saving in accordance with present principles.

FIG. 11 illustrates duration changes for segments included in the completely sped-up media content in FIG. 8 with a constraint that each segment consumes the same power after considering power saving in accordance with present principles.

FIG. 12 illustrates duration changes for segments included in the completely sped-up media content in FIG. 8 with a constraint of a specified total power consumption and total playback time after considering power saving in accordance with present principles.

FIG. 13 illustrates an example of a received completely slowed-down media content.

FIG. 14 illustrates duration changes for segments included in the completely slowed-down media content in FIG. 13 after considering power saving in accordance with present principles.

FIG. 15 illustrates a process performed by a user device process performed by the user device to control the use of the input buffer in accordance with present principles.

FIG. 16 illustrates an example of buffer level changes over in accordance with present principles.

### SUMMARY OF PRESENT PRINCIPLES

According to an exemplary embodiment of the present principles, a method is presented. The method comprises receiving media content having first and second media segments; playing back the first media segment with a first number of frames different from a second number of frames in the first media segment; and playing back the second media segment, wherein the first number is determined according to average power of the first media segment and average power of the media content.

According to an exemplary embodiment of the present principles, a device is presented. The device comprises memory configured to store a media content; and a processor configured to receive the media content having first and second media segments; and play back the first media segment with a first number of frames different from a second number of frames in the first media segment and playback the second media segment, wherein the first number is determined according to average power of the first media segment and average power of the media content.

According to an exemplary embodiment of the present principles, a computer program product stored in non-transitory computer-readable storage media is presented. The computer program comprises computer-executable instructions for receiving media content having first and second media segments; playing back the first media segment with a first number of frames different from a second number of frames in the first media segment; and playing back the second media segment, wherein the first number is determined according to average power of the first media segment and average power of the media content.

### DETAILED DESCRIPTION

An aspect of the embodiments of the present principles is directed to determining power savings or power optimizations for power that is anticipated, forecasted or estimated to be used when media content is displayed or provided. As used herein, “power savings” can be defined to include reducing consumption of power and/or energy. Power savings may further refer to “green” or energy efficient versions of media content. Power savings may further refer to power optimization based on consumption load and/or infrastructure. For example, the power may be determined based on anticipated, forecasted or estimated content power usage at an end user apparatus or device.

An aspect of the embodiments of the present principles is directed to determining power consumption of media content and/or media content segments or subunits. Thereby, power consumption or power determinations, as discussed herein reference anticipated, forecasted or estimated power consumptions and/or usage by an apparatus and/or system. The estimated power consumption may be, for example, a power consumption indicator based on a measure of a property of the content such as luminance.

As used herein, “media content” may be defined to include any type of media, including any type of audio, video, and/or image media content received from any source. For example, “media content” may include Internet content, streaming services (e.g., M-GO, Netflix, Hulu, Amazon), recorded video content, video-on-demand content, broadcasted content, television content, television programs (or programming), advertisements, commercials, music, movies, video clips, interactive games, network-based entertainment applications, and other media assets. Media assets may include any and all kinds of digital media formats, such as audio files, image files or video files.

An aspect of the embodiments of the present principles is directed to reducing power consumption when providing media content (e.g., when displaying or playing media content at an end user device). An aspect of present principles is directed to modifying or providing an option to modify a media content speed. An aspect of present principles is directed to modifying a playout time of a segment of media content based on a power consumption indication of the media content segment.

An aspect of the embodiments of the present principles is directed to power savings based on media content speed, i.e., speeding up or slowing down the presentation time. An aspect of present principles is directed to power savings based on adaptively modifying a speed at which media content is provided. An aspect of embodiments of present principles is directed to power savings based on media content speed modifications adapted to the media content. Speed modifications (e.g., a faster or a slower speed) may be performed on a slice basis, a frame-by-frame basis, a film-frame basis, a Group of Pictures (GOP) basis, a video scene basis, or any other media segment basis. An aspect of present principles is directed to increasing or decreasing a speed at which media content is provided based on media content power considerations. An aspect of present principles is directed to power savings based on modifying a speed of media content segment(s) relative other segment(s) of the same media content.

An aspect of the embodiments of present principles is directed to determining speed ranges or boundaries (e.g., the maximum speed and/or the minimum speed) based on content information. For example, speed range(s) may be determined based on one or more of media scene content, dialogue, media content geographic location (the location(s) portrayed within the media content or the location where the media content is being viewed), preferences, or viewing tolerances (e.g., maximum amount of hours that media content may be observed).

In one example, power savings may be achieved by modifying a speed of displaying or playing video segments, i.e., playout/playback time of the video segments. For example, power savings may be based on speeding up high power video segments, where the amount of speed up is constrained to be within a determined maximum speed boundary. In another example, power savings may be based on slowing down low power video segments, where the amount of slowdown is constrained to be within a determined minimum speed boundary. In one example, the power savings may be achieved while substantially maintaining the same total duration of a video.

An aspect of the embodiments of the present principles is directed to pre-processing of media content. For example, media content may be pre-processed at a content server in order to determine power savings indicators. In one example, a video may be pre-processed at a video server to determine power consumption parameters. The pre-processing at the server may provide the benefit of a server's higher computational power, higher accuracy and ability to process an entire program in order to assure substantially the same total program duration.

An aspect of the embodiments of the present principles is directed to determining power saving versions of media content. For example, an aspect of the embodiments of present principles is directed to determining a plurality of versions of media content (e.g., a program, a video). One version may be a normal version that comprises the original media content while one or more versions may be power saving versions of the original media content. The power saving versions may have substantially the same total duration as the original media content, but may have different speeds for various scenes. Substantially the same total duration may imply a media content total duration within a percentage value of the original media content duration. In one embodiment, the percentage value may be +/−5% of the original media content duration. In one example, a media content playout unit (e.g., a set top box, television, tablet, smartphone, computer or the like) may dynamically switch between the plurality of power saving versions (e.g., by switching between versions of media content segments based on user input). In another example, the media content providing unit may automatically transition between power versions of media content segments. A media content version may be chosen at a receiving device based on an energy consumption profile (e.g., per user), or other energy parameters (e.g., time of day, cost of electricity, energy consumption profiles, total energy consumption, total energy consumption at a home). In one example, power saving versions of media content may be offered along with the conventional media content (e.g., by a streaming media website such as Netflix, Amazon, M-GO, and other streaming providers). Each power saving version may include an indicator for indicating different media content speeds. These indicators may be encoded/decoded along with corresponding media content. In one example, the indicators may be metadata that is provided along with media content and/or media content segments.

An aspect of the embodiments of the present principles is directed to metadata which may indicate media content speeds. The metadata may include information regarding time stamps or media content points indicating media content speed changes. For example, the metadata may include information regarding when a media content speed is fast, slow or normal. In one example, the metadata may be generated and/or transmitted by an encoder or a content server.

At least two embodiments can be used to achieve fast speed for a media segment, which is faster than the normal speed. For example, the server can reduce the number of frames in that segment and a receiver plays back the segment at a normal speed, or the server can transmit the normal segment and the receiver plays the normal segment at a faster speed. Similarly, at least two embodiments can be used to achieve slow speed for a media segment, which is slower than the normal speed. For example, the server can increase the number of frames in that segment and a receiver plays back the segment at normal speed, or the server can transmit the normal segment and the receiver plays the segment at a slower speed.

An aspect of the embodiments of the present principles is directed to metadata indicating media content speed versions. For example, metadata may indicate a first “fast” version and a second “slow” version of the same media content or media segment. The metadata may provide flexible indications of media content speed(s). A transmitting or encoding device may provide metadata relating to different speeds or speed adjustment(s) based on content and/or energy rating(s) of media segments (e.g., video segments). A receiving device may utilize the metadata to control the speed of providing (e.g., displaying) media content. For example, a receiver can incrementally adjust media content display speed based on received metadata information. In another example, a receiving device may adjust the definition media content speed based on metadata indications of speed-up and slow-down relative to a “normal” speed.

An aspect of the embodiments of the present principles is directed to metadata that indicates various video content play speeds. Table 1 illustrates such metadata information that relates to video f contents. The “Play Speed” column relates to identifiers of different play speeds. The “Start” column indicates the starting video frame number. The “End” column indicates the ending video frame number. The “Duration” column corresponds to the total number of video frames.

TABLE 1

| Play Speed | Start | End | Duration |
|---|---|---|---|
| FAST1 | Picture Order | Picture Order | |
| | Counter = 459 | Counter = 598 | |
| FAST3 | Picture Order | | 417 frames |
| | Counter = 9488 | | |
| SLOW2 | Picture Order | Picture Order | |
| | Counter = 27987 | Counter = 30112 | |

An aspect of the embodiments of the present principles is directed to metadata that allows an achievement of power savings. The power savings may be based on metadata relating to one or more of current scene content, future scene content, program type and other media content information. The metadata may relate to speed information. The metadata may include indicators relating to one or more of speed, when speed changes are executed, duration of a speed, start of a speed change, and end of a speed change.

An aspect of the embodiments of the present principles is directed to metadata that is transmitted or received. For example, an aspect of present principles relates to determining and transmitting metadata by a transmitter. An aspect of present principles is directed to metadata that is received at a receiver. The receiver may provide media content for observation based on the received metadata. The metadata may be delivered in-band with the corresponding media content, or out-of-band as a separate file or separate stream. For example, for in-band metadata, the arrival of the metadata may indicate when a speed operation should begin and/or end. In one example, unique markers, such as presentation time stamps or picture order counts, may be used to indicate when a speed operation should begin and/or end.

An aspect of the embodiments of the present principles is directed to metadata indicating power consumption control for televisions and other appliances during high peak load time period(s). In one example, the metadata may indicate the degree of desired power saving. A consumer device (e.g., television) may provide an optimized power saving process based on the received metadata.

An aspect of the embodiments of the present principles is directed to providing enhancements to home network power consumption. For example, power consumption information of a device or apparatus may be provided to a utility service provider. The utility service provider may change either media content or metadata. Conversely, the utility service provider may provide dynamic rate information (e.g., price per kilowatt hour) to a device in order for it to adaptively control a power saving algorithm. Alternatively, the device or apparatus may modify media content based on a current energy usage. Alternatively, the apparatus can be controlled by another home appliance. In one example, the power saving determinations may be performed based on software and/or hardware. The power saving determinations may be based on parameters provided by the service provider that may optimize both or either of power consumption and user experience. The power consumption information can be integrated with whole home power consumption or room lighting to improve the experience while also reducing energy usage.

Aspects of the embodiments of the present principles may be implemented within the figures described below.

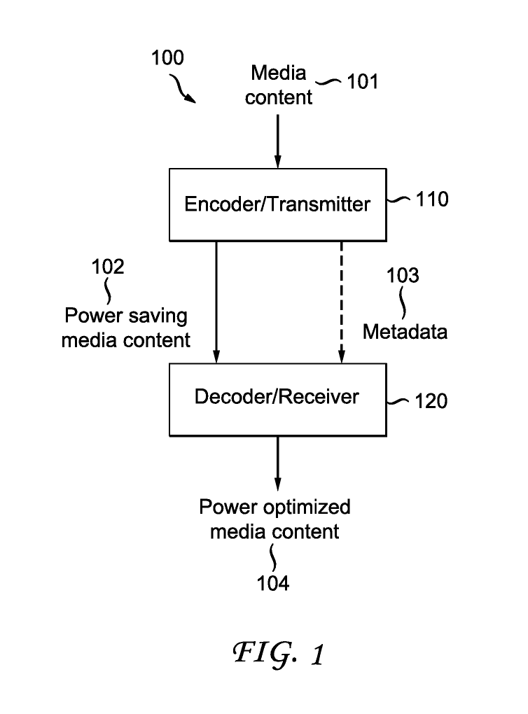

FIG. 1 illustrates a schematic diagram of a system 100 in accordance with present principles. The system 100 may include an encoder/transmitter 110 and a decoder/receiver 120.

The encoder/transmitter 110 may be an apparatus or system including: an encoder apparatus for encoding media content (e.g., video), a transmitter for transmitting power saving media content (e.g., internet protocol information), a media content server (e.g., a head-end server for preparing power saving versions of media content), and a streaming service provider (e.g., for providing streaming media content), or any other apparatus for providing media content.

The encoder/transmitter 110 may receive media content 101, which may be video content. The media content 101 may be compressed or non-compressed media content.

Examples of non-compressed media content include video in various RGB formats. Examples of compressed media content include video compressed in accordance with e.g., MPEG2, H.264, H.265, and any other video compression standards.

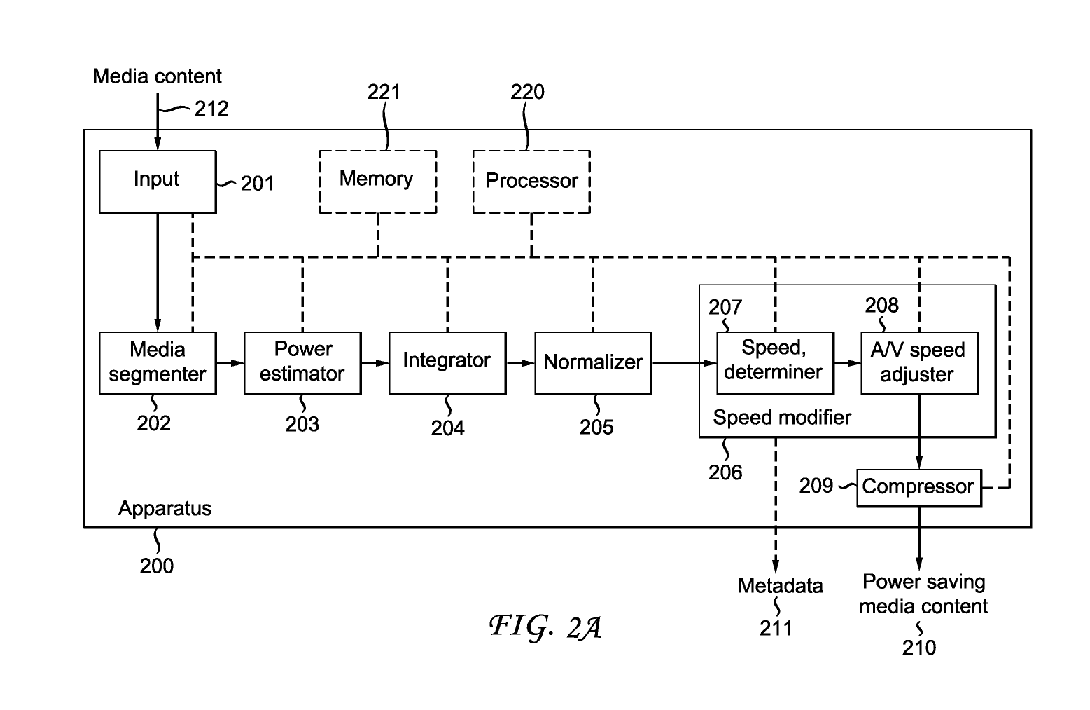

The encoder/transmitter 110 may determine power saving speed modifications for the media content 101 in accordance with any principles described herein. For example, the encoder/transmitter 110 may determine a plurality of power saving versions of media content 101. The plurality of power saving versions may then be compressed (encoded) resulting in the power saving media content 102. In another example, the encoder/transmitter 110 may determine indicators indicating different media content speeds and the times when the speeds should be applied. Such indicators may be encoded as part of metadata 103. In one example, the encoder/transmitter 110 may determine power saving speed modifications in accordance with the techniques described in connection with FIGS. 2A, 2B, 3-6 described hereinafter. The encoder/transmitter 110 may provide power saving media content 102 based on the power savings speed determinations of the media content 101.

The encoder/transmitter 110 may optionally provide the metadata 103. The metadata may indicate the speed and/or media content observation times. The power savings determinations may also be included within the metadata 103. For example, metadata 103 may be part of the power saving media content 102 or may be transmitted separately from the media content 102. When metadata is separately provided, media content 102 may be media content 101. The transmission of the metadata 103 may be via the same or different communication paths or systems other than that of the media content 102.

The decoder/receiver 120 may be an apparatus or system, including: a decoder apparatus for decoding media content (e.g., video, a receiving apparatus for receiving media content (e.g., internet protocol information), a consumer-end device (e.g., a set top box, a Blu-Ray player, a television, a smart television, a gaming console, a laptop, a full-sized personal computer, a smart phone, a tablet PC, and any other device for providing media content). The decoder/receiver 120 may receive the power saving media content 102 and the metadata 103.

The decoder/receiver 120 may determine power optimized media content 104 based on the power saving media content 102 and/or the metadata 103. The decoder/receiver 120 may perform decoding operations on the received power saving media content 102 and/or the metadata 103.

The decoder/receiver 120 may provide the power optimized media content 104 for observation. The decoder/receiver 120 may utilize the metadata 103 to control the speed of displaying power optimized media content 104. For example, the decoder/receiver 120 can incrementally adjust media content display speed based on the metadata 103. In one example, the decoder/receiver 120 may determine power saving speed modifications in accordance with the techniques described in connection with FIGS. 2A, 2B, and 3-6 described below.

FIG. 2A illustrates a schematic diagram of an apparatus 200 in accordance with present principles. Apparatus 200 may be an apparatus capable of processing instructions and generating transmittable information. The apparatus 200 may be similar to the encoder/transmitter 110 described in connection with FIG. 1. For example, the apparatus 200 may be a transmitter, an encoder, or a head-end server.

The apparatus 200 may receive media content, for example, via input 201. The media content may be in compressed or non-compressed form. Examples of compressed media content such as content which has been compressed in accordance with MPEG2, H.264, H.265, and any other compression standards. Examples of non-compressed media content include video in RGB formats. The media content may be media content as described in connection with FIG. 1. The input 201 may receive the media content for processing. The input 201 may be a video input terminal, bus, connector, input video buffer, communications port, etc.

Media segmenter 202 segments media content. The media segmenter may segment media content (e.g., a video) into media segments. In one example, media segmenter 202 segments the media content into different sections, portions, frames, blocks, Group of Pictures (GOPs), slices, scenes, fragments (such as fragmented MP4 supported in MPEG DASH), any other type of segments (e.g., as used in Segmented Adaptive Transport Stream of HLS), and any other type of time intervals (either dynamic time intervals or uniform time intervals, e.g., 2 seconds, 5 seconds). In one embodiment, the media content may already be segmented and media segmenter 202 may be optional, bypassed or removed. Power saving determinations may be performed based on these media segments. The segment size may be optimized based on practical considerations. For example, if the segments are too small, it may be difficult to change the speed. However, if the segments are too long, there may be missed opportunities for power savings.

Power estimator 203 determines power consumption for media segments that were determined by media segmenter 202. In one example, power estimator 203 may determine power consumption through any power determination method. For example, the power estimator 203 may determine an average or a normalized luminance value of pixels of respective content from each of the segmented portions. In one example, the power estimator 203 may determine an average power of a scene based on an average power of media segments that compose the scene. In one example, the average power may be determined by dividing the energy of that scene by the duration of the scene or number of frames of the scene. The average power of a media segment or a media content can be similarly determined. The power estimator 203 may estimate power consumption or energy of media segment(s) or media segment subunit(s) (e.g., frames). In one example, the power may be power that is anticipated, forecasted or estimated to be used when the media content is displayed or provided. That is, the apparatus 200 may anticipate, forecast or estimate the power that is associated with the content on an end user apparatus or device.

Integrator 204 may integrate or sum, over a time period, power consumption of media segments or subunits of a media segment. For example, the integrator 204 may integrate power of all frames in a segmented scene, thus providing a total power of the segmented scene. In one example, integrator 204 may be optional or may be only utilized based on certain conditions. For example, the integrator 204 may only be utilized when a scene has been segmented, (e.g., when a video scene is segmented into more than one video frames). The integrator 204 may sum the total power or energy of all media segments in a frame or a scene.

Normalizer 205 may determine average power consumption for a scene. In one example, the normalizer 205 may divide the energy of a scene by the number of media segments or media segments subunits in the scene. For example, the normalizer 205 may divide the total power or energy determined by integrator 204 by the number of frames in a scene evaluated by integrator 204. The normalizer 205 may determine an average power or energy per frame, per time interval, time period, or per any media segment subunit. In one example, the normalizer 205 and integrator 204 may be optional or may be integrated as part of power estimator 203.

Speed modifier 206 may receive power consumption information from at least one power estimator 203, integrator 204 and/or normalizer 205. The speed modifier 206 may include a speed determiner 207 and an audio/video (“A/V”) speed adjuster 208. In one example, the speed determiner 207 and the A/V speed adjuster 208 may be integrated into the speed modifier 206.

The speed determiner 207 determines the speed for providing each media segment. The speed determiner 207 may determine the speed of a segment based on the power consumption determined by the power estimator 203, integrator 204 and/or normalizer 205. In one example, the speed determiner 207 may determine a modified start and end time for the segment. In one example, the speed determiner 207 may determine a faster or slower speed of media content.

In one example, the speed determiner 207 may determine modified speed for one or more media segment(s) based on average power consumption. In one example, the speed determiner 207 may determine a speed based on a direct relationship to power consumption. The speed determiner may determine a speed of a media segment based on a direct relationship between an average power of the media segment and the speed of that segment. For example, if a media segment has relatively higher power consumption, then the speed determiner 207 may then increase the speed of that segment. Likewise, if a media segment has relatively lower power consumption, then the speed determiner 207 may then decrease the speed of that segment.

Generally, the speed determiner 207 may reduce the duration (or number of frames) of high power segments and increase the duration (or number of frames) of low power segments. The speed determiner 207 may also track the overall speed of the program to ensure that, despite the speed changes, the overall total time of the media content remains approximately the same. In one example, the total media content time remains the same. In another example it is less or more than the original (normal) media content time.

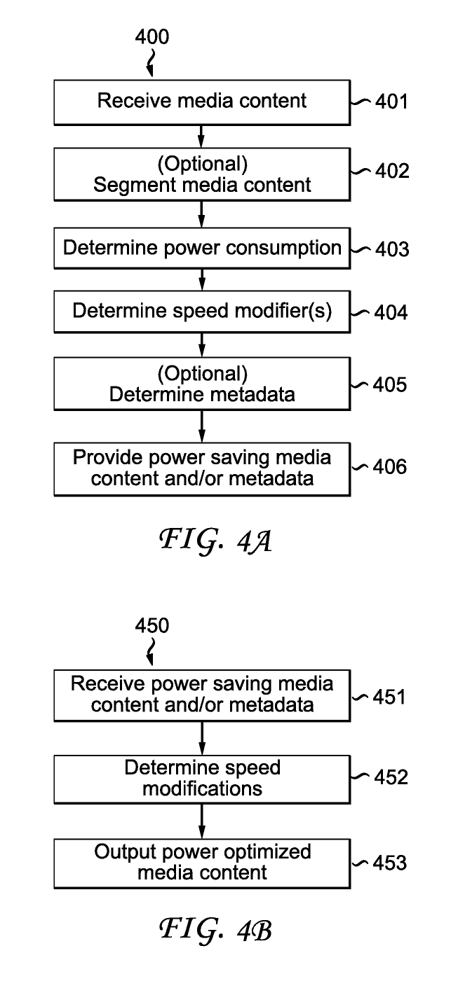

In one example, the speed determiner 207 may determine speed modifications based on shifting a reference threshold. In one example, the threshold may be determined in accordance with the principles described in connection with reference threshold 505 of FIG. 5.

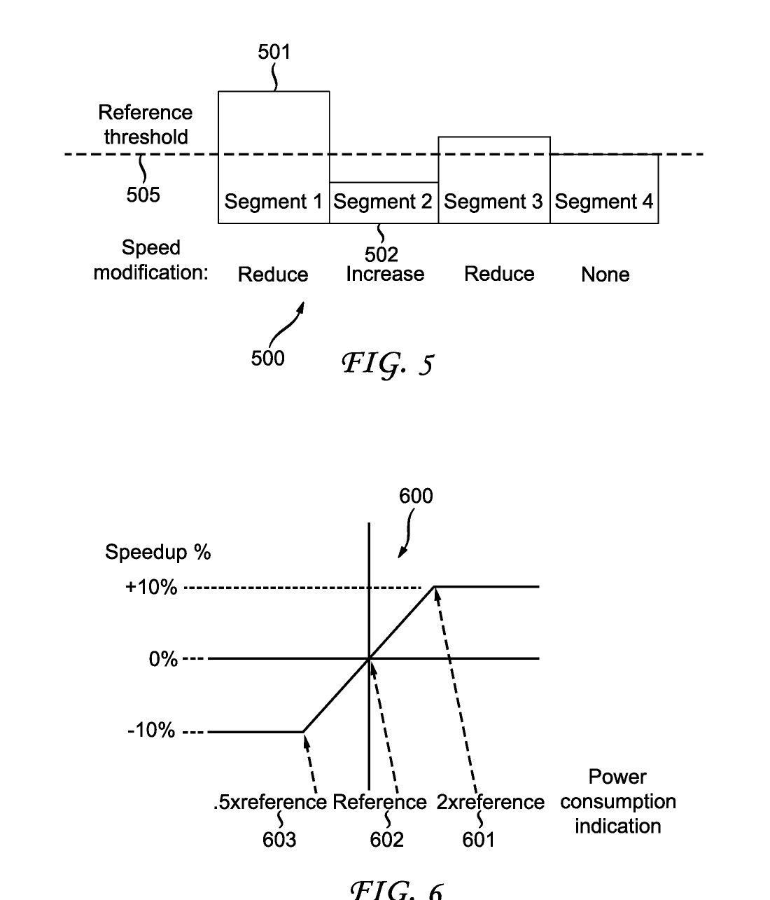

In another example, the speed determiner 207 may determine speed modifications based on a change of characteristics of a slope of transfer. In one example, the change of slope transfer characteristics may be determined in accordance with the principles described in connection with FIG. 6.

In another example, the speed determiner 207 may determine speed modifications based on changing the maximum range of allowable speeds. In one example, the speed determiner 207 may determine speed modifications based on a combination of shifting the reference threshold, changing the slope of the transfer characteristic, and changing the maximum range of allowable speeds.

In one example, the A/V speed adjuster 208 may be an audio/video speed adjustment playout unit. For example, the A/V speed adjuster 208 may increase the speed of a video segment, (e.g., by adjusting the playout or presentation times of the video segment).

Alternatively, the A/V speed adjuster 208 may decrease the speed of a video segment, (e.g., by adjusting the playout or presentation times of the video segment). In one example, the A/V speed adjuster 208 may not be utilized because metadata may indicate speed adjustments to a downstream receiving device that has its own A/V speed adjustment unit. In this case the metadata 211 is provided to the downstream A/V speed adjustment unit to guide the applied speed adjustments.

The speed modifier 206 may further determine metadata 211. The metadata 211 may be determined based on the speed modifications provided by speed modifier 206. For example, the metadata 211 may indicate media content speeds. The metadata 211 may include information regarding time stamps or media content points indicating where the media content speed changes. For example, the metadata 211 may include information regarding when a media content speed is a fast, a slow and a normal speed. Alternatively, metadata 211 may indicate media content speed versions (e.g., fast, slow, normal, and/or the actual speed). For example, metadata 211 may be metadata as described in connection with Table 1. The metadata 211 may allow for the achievement of power savings. The metadata 211 may relate to one or more of current scene content, future scene content, program type and other media content information. The metadata 211 may relate to speed information. The metadata may include indicators relating to one or more of speed, when speed changes are executed, duration of a speed, start of a speed change, and end of a speed change. In one example, the media content may be unmodified and the speed modifications may only be indicated in the metadata. In this example, the metadata includes synchronized indications of power consumption and/or playback speed. The synchronization points are media segment based and/or timestamp based.

In one example, for in-band metadata, the arrival of metadata 211 may indicate when a speed operation should begin and/or end. The metadata 211 may be synchronized with the power saving media content 210. In another example, unique markers, such as presentation time stamps or picture order counts, may be used to indicate when a speed operation should begin and/or end. In one example, the metadata 211 may include power consumption indications determined by one or more of power estimator 203, integrator 204, and normalizer 205.

The apparatus 200 may include an optional video compressor (encoder) 209. The video compressor 209 may compress the power saving media content from speed modifier 206. The compressor 209 may be part of the speed modifier 206.

The power saving media content 210 and the metadata 211 may be provided via a modulator, an output port such as an HDMI port, an Ethernet interface, a communications port, etc. The power saving media content 210 may include the metadata 211 or may be separate from metadata 211. The metadata 211 may be transmitted via the same or different paths or systems as power saving media content 210. Alternatively, the metadata 211 may also be modulated and/or assigned to a different channel, frequency, time period, data format or modulation scheme than the media saving content 210.

The apparatus 200 may further include processor 220 and memory 221. In one example, the components 201-209 of apparatus 200 may be connected to the processor 220 and the memory 221. The processor 220 may monitor and control the various hardware components for implementing the functions of components 201-209. In another example, the processor 220 may execute software to perform various functions for components 201-209.

The memory 221 may be configured to store information received from one or more of the components 201-209. The memory 221 may be one or more of a variety of memory types. For example, the memory 221 may be one or more of an HDD, DRAM, cache, Read Only Memory (ROM), a Random Access Memory (RAM), disk storage device (e.g., a magnetic or optical disk storage device), a solid state magnetic device, and so forth.

The memory 221 may store computer executable instructions configured to perform techniques for components 201-209. The memory 221 may store instructions to be performed by the processor 220. The executable instructions are accessible by the processor 220. The executable instructions may be stored in a random access memory (“RAM”) or can be stored in a non-transitory computer readable medium. Such non-transitory computer readable medium can comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that can be coupled directly or indirectly. The medium can also include any combination of one or more of the foregoing and/or other devices as well.

The apparatus 200 may further include other elements (not shown), as readily contemplated by one of skill in the art, as well as omit certain elements. For example, various other input devices and/or output devices can be included, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the apparatus 200 are readily contemplated by one of ordinary skill in the art given the teachings of the present principles provided herein.

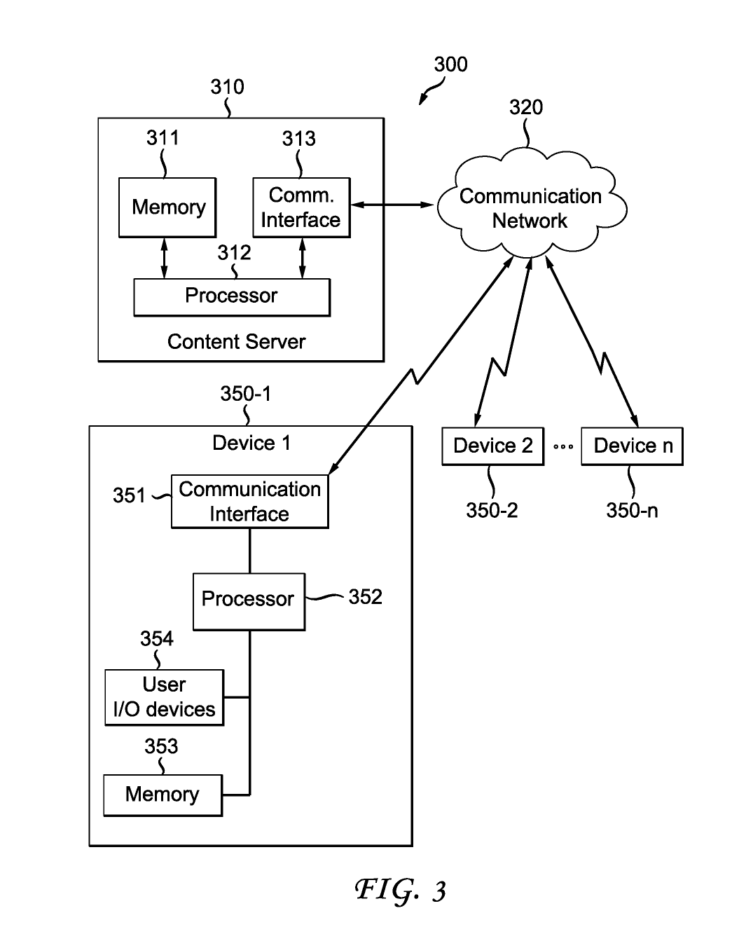

Further, it is to be appreciated that the apparatus 200 may execute techniques disclosed herein. For example, the apparatus 200 may perform in whole or in part one or more of the method(s) described in connection with FIG. 4A.

FIG. 2B illustrates a schematic diagram of an apparatus 250 in accordance with present principles. Apparatus 250 may be an apparatus capable processing instructions and receiving information. The apparatus 250 may be similar to the apparatus 120 described in connection with FIG. 1. For example, the apparatus 250 may be a receiver, a decoder, or a consumer device. The apparatus 250 may receive power saving media content 210 and metadata 211.

The apparatus 250 includes an input 251. The input 251 may be a tuner, demodulator, video input terminal, bus, connector, input buffer, communications port, and the like. The apparatus 250 may receive the power saving media content 210 via input 251. The apparatus 250 may also optionally receive the power saving media content 210 and the metadata 211 via input 251. In one example, the power saving media content 210 and the metadata 211 may be determined in accordance with the principles described in connection with FIG. 2A. In one example, the power saving media content 210 and metadata 211 may be received as described in connection with FIG. 1.

The apparatus 250 may include a speed modifier 252. The speed modifier 252 may include a speed determiner 253 and an audio/video (“A/V”) speed adjuster 254. In one example, the speed determiner 253 and A/V speed adjuster 254 may be integrated into the speed modifier 252.

The speed determiner 253 may determine speed and/or modified playout times for the power saving media content 210. In one example, the speed determiner 253 may determine the speed and/or modified playout times for each media segment based on the received metadata 211. In one example, the speed determiner 253 may analyze the metadata 211 to obtain the power consumption indications for each media segment of the power saving media content 210. In another example, the speed determiner 253 may analyze the metadata 211 to determine a speed for each of the media segments of the power saving media content 210. In one example, the speed determiner 253 may determine the speed and/or modified playout times for each media segment by selecting between power saving versions of that media segment. In another example, the speed modifier 252 and/or the speed determiner 253 may receive media content that already has modified speeds to optimize power of the media content.

In another example, the speed modifier 252 may further include a media segmenter, a power estimator, an integrator, and/or a normalizer to determine how to provide the power optimized media content. In one example, the media segmenter, the power estimator, the integrator, and/or the normalizer may correspond to the media segmenter 202, the power estimator 203, the integrator 204 and the normalizer 205 described in connection with apparatus 200 in FIG. 2A. In one example, the A/V adjuster 254 may modify the media content in accordance with the principles described in connection with A/V adjuster 208 of FIG. 2A.

In one example, a utility service provider may provide dynamic rate information (e.g., price per kilowatt hour) to apparatus 250 in order for it to adaptively control a power saving algorithm. Apparatus 250 may modify media content based on a current energy usage. Apparatus 250 can be controlled by another home appliance. Apparatus 250 may perform power saving determinations based on parameters provided by a service provider that may optimize both or either of power consumption and user experience. Apparatus 250 may integrate power consumption information with home power consumption or room lighting to improve experience while also reducing energy usage.

The speed modifier 252 may output power optimized media content to an optional output 255. The output 255 may be a modulator, an output port such as an HDMI port, or a communications port. The output 255 may output power optimized media content (such as video content) to a display device and/or speakers 260. Accordingly, the power optimized media content may be provided to a user for viewing in an energy saving manner.

The apparatus 250 may further include processor 256 and memory 257. In one example, the components 251-255 of apparatus 250 may be connected to the processor 256 and the memory 257. The processor 256 may monitor and control the various hardware components for implementing the functions of components 251-255. In another example, the processor 256 may execute software to perform various functions for components 251-255.

The memory 257 may be configured to store information received from one or more of the components 251-255. The memory 257 may be one or more of a variety of memory types. For example, the memory 257 may be one or more of an HDD, DRAM, cache, Read Only Memory (ROM), a Random Access Memory (RAM), disk storage device (e.g., a magnetic or optical disk storage device), a solid state magnetic device, and so forth.

The memory 257 may store computer executable instructions configured to perform techniques for components 251-255. The memory 257 may store instructions to be performed by the processor 256. The executable instructions are accessible by the processor 256. The executable instructions may be stored in a random access memory (“RAM”) or can be stored in a non-transitory computer readable medium. Such non-transitory computer readable medium can comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that can be coupled directly or indirectly. The medium can also include any combination of one or more of the foregoing and/or other devices as well.

The apparatus 250 may further include other elements (not shown), as readily contemplated by one of skill in the art, as well as omit certain elements. For example, various other input devices and/or output devices can be included, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the apparatus 250 are readily contemplated by one of ordinary skill in the art given the teachings of the present principles provided herein.

Further, it is to be appreciated that the apparatus 250 may execute techniques disclosed herein. For example, the apparatus 250 may perform in whole or in part one or more of the method(s) described in connection with FIG. 4B.

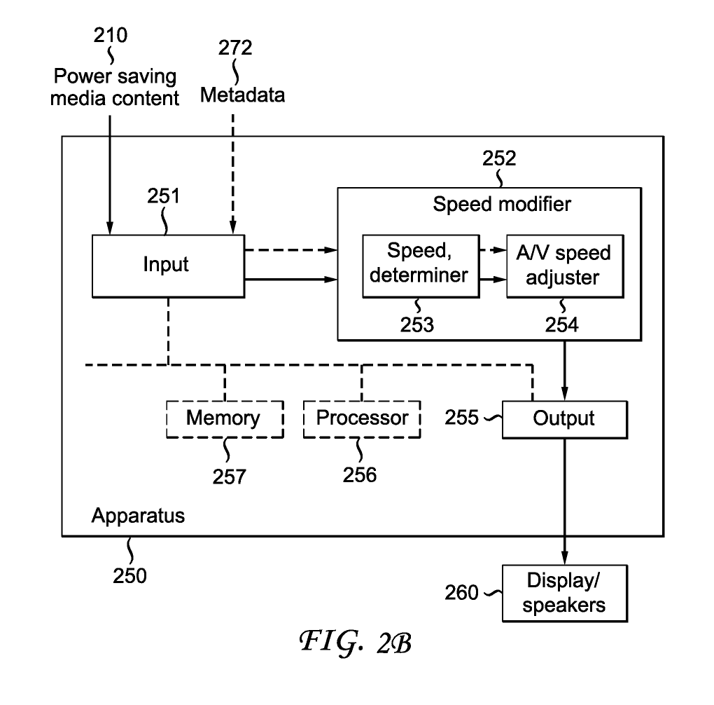

FIG. 3 shows an exemplary system 300 in accordance with present principles. As illustrated, system 300 is an example in accordance with present principles that includes communication network 320. The communication network 320 may be a communication network such as the internet, a wide area network (WAN), and/or a local area network (LAN). The communication network 320 may also include a broadcast network via cable, satellite, phone lines, power lines or other medium. Thereby, system 300 allows for the streaming, uploading and/or downloading of media content via the communication network 320.

The system 300 may include a content server 310. The content server 310 may receive requests from one or more of devices 350-1 to 350-n. The content server 310 may transmit media content such as movies or TV shows for streaming or downloading. The devices 350-1 to 350-n may communicate with the content server 310 over the communication network 320.

The content server 310 may transmit information such as data, web pages, media contents, etc. The content server 310 may provide additional processing of information when the processing is not available and/or capable of being conducted on the local user devices 350-1 to 350-n.

In one example, the content server 310 includes a memory 311, a processor 312 and a communication interface 313. The content server 310 may provide media content and its associated metadata. The media content and associated metadata may be stored in the memory 311 and processed by the processor 312. The memory 311 may be non-transitory storage media, such as one or more hard drives and/or other suitable memory devices. The communication interface 313 may allow the content server 310 to transmit data via the communication network 320.

In one example, the content server 310 may be similar to apparatus 110 described in connection with FIG. 1. In another example, the content server 310 may be similar to the apparatus 200 described in connection with FIG. 2A.

The devices 350-1 to 350-n are devices for receiving the media content. In one example, such devices may include a set-top box, a computer, a laptop, a tablet, a cellphone, etc. In one example, device 350-1 illustrates a detailed block diagram of an exemplary user device. The device 350-1 includes a communication interface 351, processor 352, memory 353, and an option user I/O interface 354. The communication interface 351 allows for communication, e.g., receiving of information, from the communication network 320. The processor 352 may process the power saving aspects for providing received media content information. The memory 353 may represent both a transitory memory such as RAM, or a non-transitory memory such as a ROM, a hard drive or a flash memory, for processing and storing different files and information. In one example, the devices 350-1 to 350-n may be similar to apparatus 120 described in connection with FIG. 1. In another example, the devices 350-1 to 350-n may be similar to the apparatus 250 described in connection with FIG. 2B. In yet another embodiment, the devices 350-1 to 350-n may be similar to the apparatus 200 described in connection with FIG. 2A.

FIG. 4A illustrates a flow diagram of an exemplary method 400 in accordance with present principles. The method 400 may determine power saving media content.

The method 400 may include a block 401 for receiving media content. The media content may be in compressed or non-compressed form. Examples of compressed media content such as content which has been compressed in accordance with MPEG2, H.264, H.265, and any other compression standards. Examples of non-compressed media content include video in RGB formats. The media content may be media content as described in connection with FIGS. 1 and 2A. Block 401 may pass control to block 402.

Block 402 may segment the media content into media segments. In one example, block 402 may segment the media content in accordance with the principles described in connection with media segmenter 202 of FIG. 2A. Block 402 may pass control to block 403. In one embodiment, block 402 may be optional. In one embodiment, block 402 may be removed.

Block 403 may determine power consumption for media segments. In one example, block 403 may determine power consumption based on the luminance value of pixels of each media segment. Block 403 may determine power consumption in accordance with the principles described in connection with components 203-205 of FIG. 2A. Block 403 may pass control to block 404.

Block 404 may determine speed modifications in accordance with present principles. In one example, block 404 may determine a modified playout time corresponding to the respective content of the plurality of the portions of the media content. In one example, block 404 may determine the speed of a media segment based on power consumption determination(s). In one example, block 404 may determine a modified start and end time for a media segment. In one example, block 404 may determine speed modifications in accordance with the principles described in connection with components 205-208 of FIG. 2A. Block 404 may pass control to block 405.

Block 405 may determine metadata for the media content. Block 405 may determine metadata related to the power consumption determination and the speed modifications determination of block 403 and 404, respectively. In one example, block 405 may determine metadata which indicates media content speeds in accordance with present principles. For example, the metadata may include information regarding the speed for a media segment (e.g., whether the speed is fast, slow or normal). In one example, block 405 may generate metadata that indicates start and end times for a media content segment. In one example, block 405 may determine metadata that may indicate when a speed operation should begin or end. The metadata may further include indicators relating to one or more of speed, when speed changes are executed, duration of a speed, start of a speed change, and end of a speed change. In one example, block 405 may determine metadata indicating media content speed versions. For example, metadata may indicate a first “fast” fast version and a second “slow” version of the same media content or media segment. The metadata may provide the flexibility of indicating the various speeds of the media content. For example, a transmitting or encoding device may provide information in the metadata relating to different levels of playback speed adjustments based on content and/or energy rating(s) of media content segments (e.g., video segments). In one example, block 405 may determine metadata in accordance with the principles described in connection with metadata 211 of FIG. 2A. In one embodiment, 405 may be optional. In one embodiment, block 405 may be removed. In one example, 405 may be optional. Block 405 may pass control to block 406.

Block 406 may provide the power saving media content and metadata. In one example, block 406 may transmit power saving media content and metadata. In one example, the power optimized media content may be determined in accordance with the principles described in connection with the power saving media content 210 of FIG. 2A. In one example, block 406 may determine metadata in accordance with the principles described in connection with metadata 211 of FIG. 2A. In one example, block 406 may transmit the power saving media content and the metadata in accordance with the principles described in connection with FIG. 2A.

In one example, block 406 may deliver the metadata in-band with the corresponding media content, or out-of-band as a separate file or separate stream. In one example, block 406 may provide the metadata to downstream devices or receivers.

In one example, block 406 may not provide metadata and may instead only provide power saving media content. For example, the power saving media content may be determined by performing actual modification to the media content segment(s) (e.g. by modifying the respective playout times based on the determined power consumption indications). Such modifications may be in response to an external power management signal. The signal may be from a power utility provider, a home appliance and/or a home network. For example, this signal may be sent from the power utility provider at peak power demand time in order to reduce the overall power demand by its customer base.

FIG. 4B illustrates a flow diagram of an exemplary method 450 in accordance with present principles.

The method 450 may include a block 451 for receiving power saving media content and/or metadata. Block 451 may process received power saving media content in accordance with the principles described in connection with input 251 of FIG. 2B. Block 451 may pass control to block 452.

Block 452 may determine speed modifications in accordance with an embodiment of the present principles. In one example, block 452 may determine a modified playout time corresponding to the respective content of a plurality of the portions of the media content. In one example, block 452 may determine a modified start and end time for a media content segment. For example, block 452 may determine a faster or slower speed than the normal speed of the media content. Block 452 may determine speed modifications as described in connection with components 252-254 described in connection with FIG. 2B.

In one example, block 452 may determine media content speed based on metadata. In one example, block 452 may determine the speed of a segment based on the power consumption metadata indications. In one example, block 452 may utilize the metadata to control the speed of displaying media content. In one example, the speed modifications based on metadata may be determined in accordance with the principles described in connection with components 252-254 of FIG. 2A.

In one embodiment, block 452 may determine media content speed based on a reference power threshold in accordance with the principles described in connection with FIG. 6. The reference threshold is stored in a user device and may be entered or changed by the user. The metadata may indicate an average power consumption per unit, such as time or frame, and the user may indicate more or less than the average power consumption per unit. For example, block 452 may ask the user to enter the power threshold and the user can enter, for example, 10% or −10% indicating that the user want the average power consumption per unit be increased by 10% or −10%. Thus, block 452 produces a modified power saving content that is optimized according to the reference threshold. Block 453 outputs the optimized media content.

In one example, the metadata may be optional and block 452 may instead only receive power saving media content. The received power saving media content may already contain modified speed or playout time indications.

Block 453 outputs power optimized media content. The power optimized media content may be provided for display, e.g., display 260.

Methods 400 and 450 of FIGS. 4A and 4B may be implemented as a computer program product comprising computer executable instructions which may be executed by a processor. The computer program product having the computer-executable instructions may be stored in the respective non-transitory computer-readable storage media of the respective above mentioned devices.

FIG. 5 illustrates an example of a plot diagram 500 illustrating modified playout time determination(s) in accordance with present principles. In FIG. 5, an exemplary reference threshold value 505 illustrates a reference power consumption. The reference threshold 505 may be selected by a user or may be determined (e.g., based on average power value of frames of video content, such as a whole movie, TV show). Modified media content playout times may be determined based on the reference threshold 505. The modified playout times may be determined in accordance with the principles described in connection with FIGS. 1-4. If a media segment's power consumption is larger than the reference threshold 505, the media segment's playout time may be reduced, (see, e.g., segment 1 (501)). On the other hand, if a media segment's power consumption is lower than the reference threshold 505, the media segment's playout time may be increased, (see, e.g., segment 2 (502)). FIG. 5 further illustrates a segment 3 that is above the reference threshold 505 (thus its media playout time may be reduced) and a segment 4 that is at the reference threshold (thus its media playout time may be kept the same).

FIG. 6 illustrates an exemplary speed modification transfer function 600. The transfer function 600 indicates the amount of modifications to media content play out speed versus the unmodified media play out speed to achieve determined power consumption over the duration of media content playout.

FIG. 6 further illustrates exemplary thresholds 601, 602 and 603 of media content segments. The x axis of the transfer function 600 indicates power consumption. The y axis of the transfer function 600 indicates percentage of media content speed changes. As shown in FIG. 6, threshold 602 may be a reference threshold corresponding to a first media segment. A reference threshold may indicate desired power consumption. The power consumption of the threshold 601, corresponding to a second media segment, is twice that of the reference threshold 602. Therefore, the playout speed of the threshold 601 is increased by 10% relative to the playout speed of the reference threshold 602. The power consumption of the threshold 603, corresponding to a third media segment, is half that of the reference threshold 602. Therefore, the playout speed of the threshold 601 is decreased by 10% relative to the playout speed of the reference threshold 602. In one example, the transfer function 600 allows for maximum adjustments of ±10% to the playout speeds. However, ranges of adjustments may be utilized for transfer function 600 or any other power transfer function. In one example, the range of adjustment may be set by a user or may be determined based on provided parameters. In one example, a speed modifier may adjust or normalize the modified playout times corresponding to the respective contents so that a total playout time of the complete video content appears to a viewer to be essentially unmodified. The “aggressiveness” of speed modification may be controlled by at least one of shifting the reference threshold, changing the slope of the transfer characteristic, changing the maximum range of allowable speeds, or a combination thereof.

In one embodiment, the content server 310 may transmit a completely sped-up or slowed-down version of a media content. In a completely sped-up version, each segment of the media content is sped up by the same amount, for example, 10%, and in a completely slowed-down version, each segment of the content is slowed down by the same amount, for example, by 10%. When a media segment is sped up by X %, the number of frames in that media segment is reduced by X %. As such, if X is large enough, at least one frame in that media segment is deleted. The deleted frames should be equally distributed across the segment, so that the temporal resolution is about the same for the sped-up segment. If a sped-up segment is generated by re-encoding a coded segment, the temporal resolution should be about the same. Similarly, if a media segment is slowed down by X %, the number of frames in that media segment is increased by X %. As such, if X is large enough, at least one frame is inserted into that media segment. The inserted frame should be equally distributed across the segment, so that the temporal resolution is about the same for the slowed-down segment. If a slowed-down segment is generated by re-encoding a coded segment, the temporal resolution should be about the same.

An advantage of transmitting a completely sped-up version is that the transmission bandwidth is reduced. Using the low-bandwidth (and low temporal resolution) version could be preferable to media service operators such as Comcast or DirecTV, in that they would be able to fit more media content into their available bandwidth. They have already done this by compressing many of their channels so the full resolution of the original source material is not available to the CPE (customer premises equipment).

The low-bandwidth version could apply better to live content, in that a certain amount of content would need to be buffered before a speed-up could be done on live content, and a low-bandwidth version would arrive in real-time faster than it is played out, so the amount of time required to gain a big enough buffer could be drastically reduced. It is also possible in this scenario that the first X minutes of the content would always be slowed down to real-time or slower to speed the buffer acquisition even more (potentially lowering the power savings slightly, but making the “live TV” scenario more of a realistic possibility). This creates an issue for users that join the broadcast late, however, in that the live content at the time they are joining has probably already been streamed.

A completely slowed-down version may be favorable to some users, such as cinephiles, who are willing to accept the higher bandwidth and longer download times to get higher temporal resolution content. It should be noted that if the completely sped-up or slowed-down version is compressed (encoded) content, the original (normal) media content provided from a content provider should be re-encoded to decrease the number of frames in each segment in case of producing a completely sped-up version and to increase the number of frames in each segment in case of producing a completely slowed-down version.

A user device such as user device 350-1 can receive an original version of a media content, a power saving version of the media content, a completely slowed-down version of the media content, or a completely sped-up version of the media content. In the following illustration, the user device 350-1 is used as an example. The user device 350-1 includes a first buffer (not shown), which is part of the memory 353 or a separate memory controlled by the processor 352, for storing incoming media content. The processor 352 separates the audio and video portions at the first buffer and transmits them to audio and video processing units (not shown), respectively. The first buffer is a transport buffer if the media content is encoded and the audio and video processing units would be the audio and video decoders, respectively. The user device 350-1 also includes a display interface (not shown) for interfacing with a display (not shown), which may be integrated or attached to the user device 350-1. The display interface is controlled by the processor 352 and includes a picture buffer (not shown) for storing a picture (decoded frame) to be displayed by the display. The picture buffer may be part of the memory 353 or a separate memory.

The picture buffer may be able to store one frame or two frames. In the case of storing two frames, the picture buffer is divided into first and second areas and the processor 352 of the user device 350-1 alternatively updates frames in the two areas. That is, for each update period, the processor 352 updates the frame in a different area. In the case of storing two frames, the processor 352 alternatively presents frames from the two areas to the display. That is, in each presentation period, the processor 352 presents a frame to the display from a different area of the picture buffer. In the case that the presentation frame rate and picture updating frame rate are the same in a normal playback, the presentation and updating should be synchronized, so that if one area is updated, the other area should be presented. The presentation frame rate may be a default frame rate of the user device 350-1 or provided by the received media content and/or can be modified by the user. If the processor 352 updates the frame in the picture buffer slower than the presentation frame rate, the same frame in the picture buffer may be displayed in the next presentation frame interval (period). Thus, the number of frames during playback is more than the number of frames in the media segment. Thus, the playback speed is slowed down if the picture buffer updating frame rate is the same as the presentation frame rate. On the other hand, if the processor 352 updates the frame in the picture buffer faster than the presentation frame rate, some frames may not be displayed, thus, the number of frames during playback is less than the number of frames in the media segment. Thus, the playback speed is increased even though the presentation frame rate remains the same.

The picture updating rate may be coupled to the decoding rate. That is, the processor 352 updates the picture buffer once a decoded frame is available.

In one embodiment, the processor 352 may keep the picture buffer updating rate the same as the presentation frame rate but inserting frames in a segment to slow down the playback of the segment or skipping/deleting frames in a segment to speed up the playback of the segment.

It should be noted that the reference of the playback speed for a media segment is the normal speed, which is the speed for playing back the original version of the media content segment from which the segment is derived. In a normal playback for any version of the received media content, whether it is original, slowed-down, or sped-up, the decoding frame rate and picture buffer updating frame rate are the same as the presentation rate to the display. A slowed-down segment is slowed down because it has more frames than the corresponding segment in the original version and it takes more time to play back the same segment than playing back the original segment from which the slowed-down segment is derived. The playback speed of a slowed-down segment is slowed down by a factor, which is the ratio of the number of frames in the slowed-down segment to the number of frames in the original version. Similarly, a sped-up segment is sped up because it has fewer frames than the corresponding segment in the original version and takes a shorter time to play back the sped-up segment than playing back the original segment from which the sped-up segment is derived. The playback speed of a sped-up segment is increased by a factor, which is the inverse of the ratio of the number of frames in the sped-up segment to the number of frames in the original version. As such, slowing down a playback of a segment as used herein means playing back more frames than the number of frames included in the segment, and speeding up a playback of a segment means playing back fewer frames than the number of frames included in the segment. Similarly, slowing down a playback of a group of frames means playing back more frames than the number of frames included in the group, and speeding up a playback of a group of frames means playing back fewer frames than the number of frames included in the group.

When the processor 352 receives a media content, the process 352 may inform the user of the version of the received media content and ask the user to select one of the options, such as playing back as is or performing a power saving function.

If the received media content is the original version and the user selects the option of performing power saving function, the processor 352 may ask the user to specify a reference power threshold, which may indicate a percentage relative to the average power per unit of the received media content. For example, 10 indicates 10% less than the average power per unit of the received media content. The average power per unit of the received media content may be included, for example, in the metadata associated with the media content. If average power per unit of the media content is not available, the processor 352 should determine the average power per unit of the media content. The processor 352 may decode each segment, if the received media content is coded, and determine the average power per unit of that segment. If the average power per unit of the segment is lower than the specified power threshold, the number of frames or the play duration of that segment is increased. The processor 352 may accompany the increase by inserting frames or updating the picture buffer in a rate slower than the presentation frame rate, as discussed above. An inserted frame may be a repeated frame or a frame interpolated from the neighboring two frames. If the average power of the segment is higher than the specified power threshold, the number of frames or the play duration of that segment is reduced. The processor 352 may accompany the decrease by skipping frames or updating the picture buffer in a rate higher than the frame rate, as discussed above.

If the received media content is the power saving version and the user selects the option of performing a power saving function, the processor 352 may indicate to the user the current power threshold and if the user still wants to change the power threshold, ask the user to specify a reference power threshold. The process of adjusting the number of frames to be played back is the same as that described with respect to the original version.

If the received media content is either the completely sped-up or completely slowed-down version, the processor 352 should indicate to the user that the viewing time is reduced for a completely sped-up version and increased for a completely slowed-down version before the user has made the selection of playing back as is. If the user wants to change the power threshold, the user is asked to specify a reference power threshold. The process of adjusting the number of frames to be played back is the same as that described with respect to the original version.

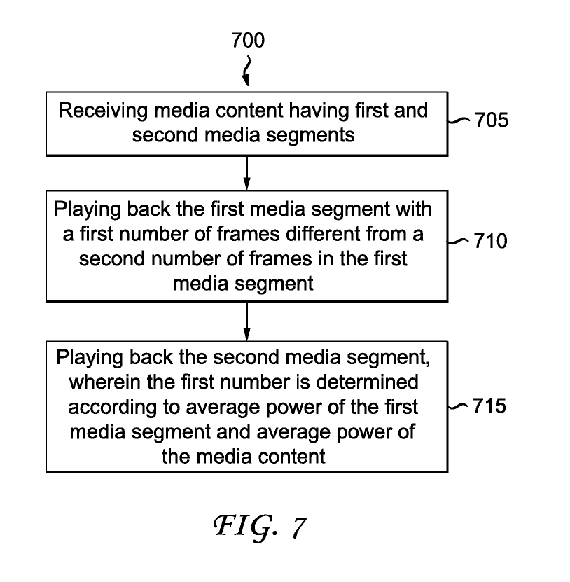

FIG. 7 illustrates a process 700 performed by the processor 352 when the user selects the option of performing a power saving function for all versions of a received media content. At step 705, the processor 352 is operative or configured to receive the media content having first and second segments. At step 710, the processor 352 is operative or configured to play back the first media segment with a first number of frames different from a second number of frames in the first media segment. For example, even if the first media segment has 10 frames, the processor 352 may play back the first media segment with more or less than 10 frames.

At step 715, the processor 352 is operative or configured to play back the second media segment, wherein the first number is determined according to average power of the first media segment and average power of the media content. As pointed out previously, the average power of a media segment can be computed by dividing the power of the media segment by the number of frames in that media segment or by the duration of time of that media segment. Also as pointed out previously, the power of a frame, a media segment, and a media content can be computed by summing all luminance values of all pixels in the frame, the media content, and the media content, respectively. The power of a media segment is directly correlated to power consumption of a playback device. For example, the higher power of a media segment requires higher power consumption of the playback device, as pointed out previously.

The second number indicates the number of frames included in the first media segment. The first number, representing the number of frames to be played back for the first media segment, can be derived from metadata associated with the first media segment. Similarly, the third number representing the number of frames of the second segment to be played back can be derived from the metadata associated with the second segment. The third number may be different from the fourth number indicating a number of frames included in the second media segment. The metadata may indicate the playback number and the number of frames included in each media segment directly. The metadata may indicate relative decoding frame rate with respect to the presentation frame rate. For example, if the presentation frame rate is 30 frames/second and the specified decoding frame rate is 15 frames/second for the first segment, the first number would be twice the second number. On the other hand, if the presentation frame rate is 30 frames/second and the specified decoding frame rate is 60 frames/second for the first segment, the first number would be half of the second number. In both cases, the added or deleted frames are equally distributed across the media segment. The metadata may also indicate the third number by specifying the start time and end time or the duration of playing back the first segment. For example, if there are 30 frames in the first segment, the presentation frame rate is 30 frames/second, and the metadata associated with the first segment indicates a duration of half a second, the first number is half of the second number, and if the metadata indicates a duration of 2 seconds, the first number is twice the second number. The same principles apply to the second segment and each of the other segments in the media content. The server should determine these two numbers according to an average power per unit of the media content, an average power per unit of the first and second media segments, and a power threshold. As stated above, power of a frame can be computed according to luminance values of pixels of that frame.

If the first and third numbers are not available or cannot be derived from the metadata, the processor 352 is operative or configured to determine these two numbers according to an average power per unit of the media content, an average power per unit of the first and second media segments, and a power threshold, which may be a default stored in the memory 353 or entered by the user upon request by the processor 352. Any of the average powers per unit of the media content, the first media segment, and the second media segment may be received from the metadata. If any one of them is not available, the processor 352 is operative or configured to determine the missing one according to the principles described previously.

Once the average power per unit of the media content and average power per unit of the first media segment are available, the processor 352 can determine the first number accordingly. If the average power per unit of the first media segment is larger than the average power for the media content, the processor 352 is operative or configured to determine that the first number is smaller than the second number and if the average power per unit of the first media segment is smaller than or equal to the average power for the media content, the processor 352 is operative or configured to determine that the first number is larger than or equal to the second number. For example, the first number is determined to be the product of the second number and the ratio of the average power per unit of the media content and average power per unit of the first media segment. The product is preferably rounded up to an integer. The third number can be similarly derived. The number of frames for playing back each of other segments can be determined in a similar manner.

In one embodiment, if the received media content is a completely slowed-down version, those segments having power consumption lower than the average power of the media content are preferably not adjusted to further slow down the playback speed by increasing the number of frames or decreasing the decoding and/or picture buffer updating frame rate, and if the received media content is a completely sped-up version, those segments having power higher than the average power of the media content are preferably not adjusted to further speed up the playback speed by decreasing the number of frames or increasing the decoding and/or the picture buffer upgrading frame rate.

In one embodiment, the processor 352 receives a total number of frames to be played back for a received media content from, for example, metadata associated with that received media content. This received total number in the metadata may be different from the total number of frames in the received media content and the number of frames determined to be played back. If the determined playback number is not the same as the received total number in the metadata, the determined playback number of frames for each segment may be adjusted. For example, if the determined playback number is more than the received total number in the metadata, the playback numbers for the slowed-down segments (those segments having playback numbers more than actual numbers of frames in the received media content) should be proportionally increased, and if the determined playback number is less than the received total number in the metadata, the playback numbers for the sped-up segments (those segments having playback numbers less than actual numbers of frames in the received media content) should be proportionally reduced. This way, the determined playback number is substantially the same as the received total number, such that the difference in playback durations are within a threshold, such as, but not limited to, three seconds.

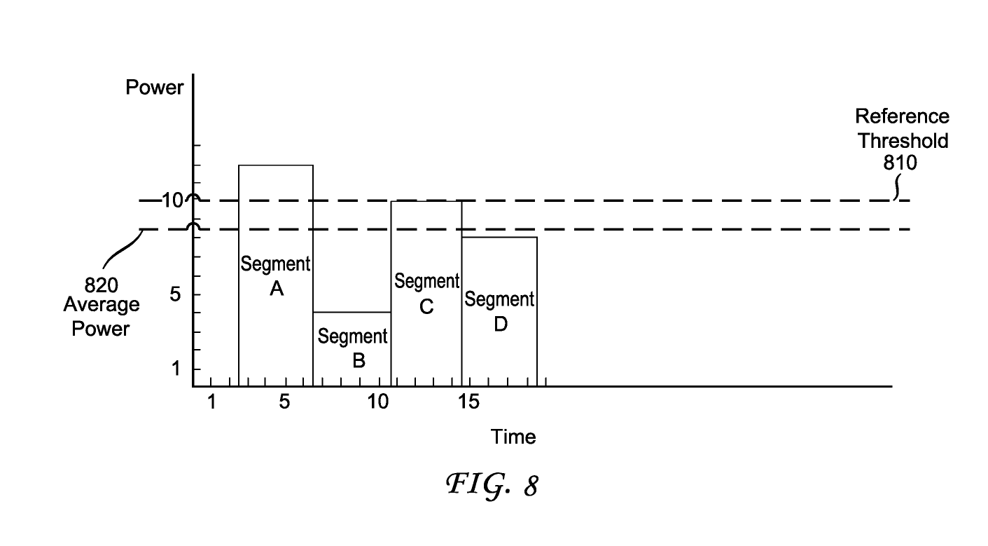

FIG. 8 shows an example of a completely sped-up media content received by user device 350-1 having four segments: segments A, B, C, and D. In FIGS. 8 to 14, the vertical and horizontal axes represent instantaneous power and time, respectively. For simplicity of the explanation, each block in the vertical direction is one power unit/time unit, and each block in the horizontal direction is one time unit. For example, if the luminance value of the pixel is ranged from 0 to 255, one power unit may be equivalent to, but not limited to, 50 million luminance values and the time unit may be, but not limited to, a second. Depending on the type of display used by the user device 350-1, a user may be able to store a conversion table in the user device 350-1 converting a power unit/unit time into, for example, kilowatts/second, or amount of money per second or minute or hour.

In FIG. 8, the reference power threshold 810 is either a default value, a value entered by a user, or a value included in the metadata. The average power 820 in this example is 8.5 power units/time unit. The average power 820 can be provided by the server through, for example, metadata. In this example, the reference power is 10, which is (10-8.5)*100/8.5 percent or about 17.6% more than the average power indicating that the user wants to lengthen the playback time duration even if more playback power is needed. As can be seen, each segment illustratively has the same duration of 4 time units but different power. This is only an example, each segment may have a duration different from that of another segment.

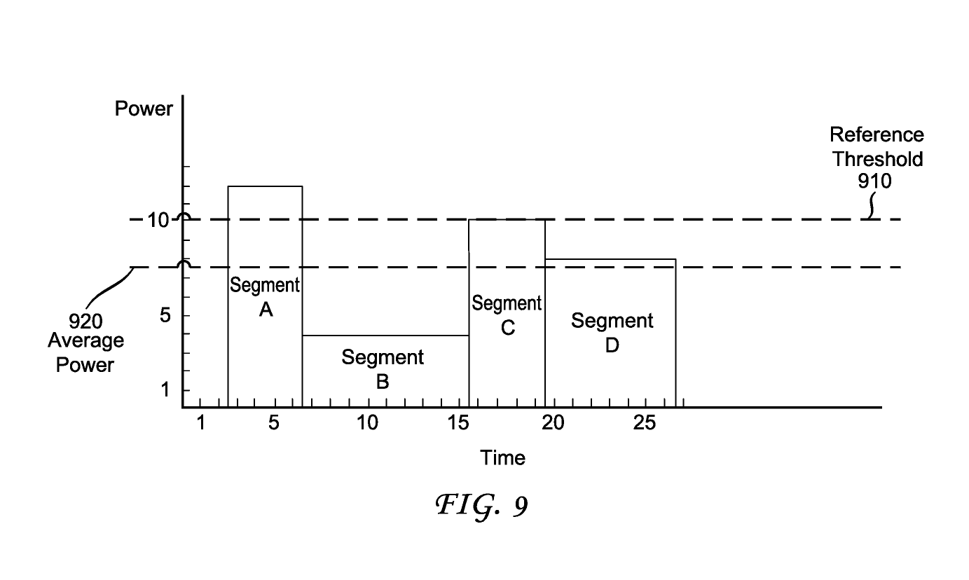

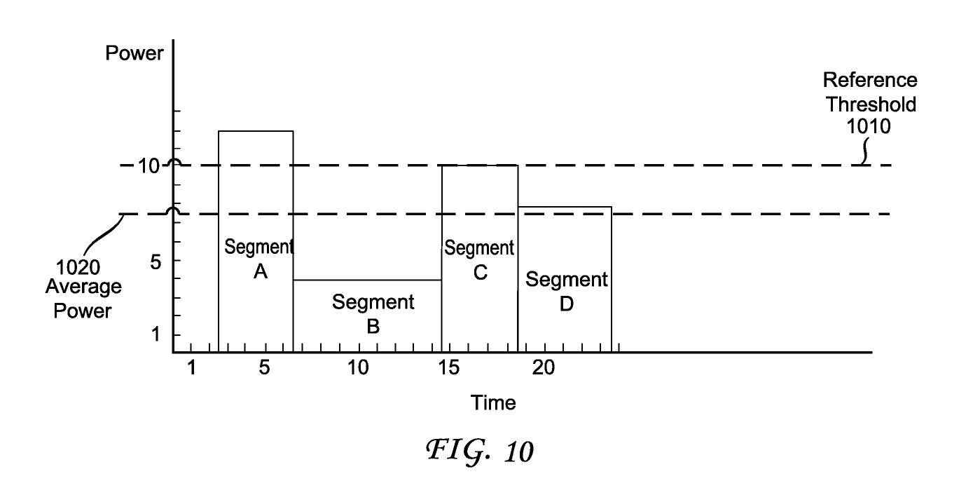

Since the media content received is a completely sped-up version, in one embodiment, the objective is to slow down those segments having average power lower than the reference threshold 810 and not to further speed up those segments having average power over the reference power threshold 810. Segment A has an average power larger than the power threshold 810 and it should not be sped up further. As such, the adjusted playback time duration for segment A remains as 4 time units, i.e., the number of frames in segment A after adjustment is the same as the number of frames included in segment A. Segment C has an average power equal to the power threshold 810. As such, the playback duration remains the same after the adjustment. Segments B and D have average powers smaller than the power threshold 810. As such, the processor 352 determines that the playback time duration or number of frames for either segment must be increased, i.e., slowing down the playback of either segment. FIGS. 9 and 10 show two examples of the playback time duration of each segment after the adjustment.

The user may enter the kilowatt or amount of money/unit time constraint and the processor 352 may convert the entered data into power units/time unit. For example, in FIG. 9, the processor 352 converts the user desired power consumption into 7.5 power units/unit time as average power 920. The reference power threshold 910 is the same as reference power threshold 810 in FIG. 8. The power of segments A and C are 4*12 (48) and 4*10 (40), respectively, and they are not changed, as described above. Assuming that the maximum time that a segment can be played back is 9 time units, the processor is operative or configured to extend the playback time for segment B from 4 time units to 9 time units and determine that the playback time for segment D should be extended from 4 time unit to 7 time units in order to meet the requirement of an average power consumption of 7.5 power units/unit time. If there is no limitation on the playback time duration for each segment, the allocation of playback time durations of segments B and D should be inversely proportional, in any manner, to the respective average power of each segment.

The user may specify the total power of playing back the four segments and the adjusted playback time duration for each segment is shown in FIG. 10 as an example. The reference power threshold 1010 is the same as reference power threshold 810 in FIG. 8. The processor 352 may decide that increasing in playback time duration in segments B and D should be inversely proportional to the square of the respectively average power of segments B and D, and determines that the playback time duration for segment B is increased from 4 to 8 time units and the playback time for segment D is increased from 4 to 5 time units in order to meet the total consumption of 160 power units. Other algorithm in distributing playback time duration increases for segments B and D can be used. For example, a segment, such as segment B, with lower average power should be extended more than a segment, such as segment D, with higher average power than that of segment B.

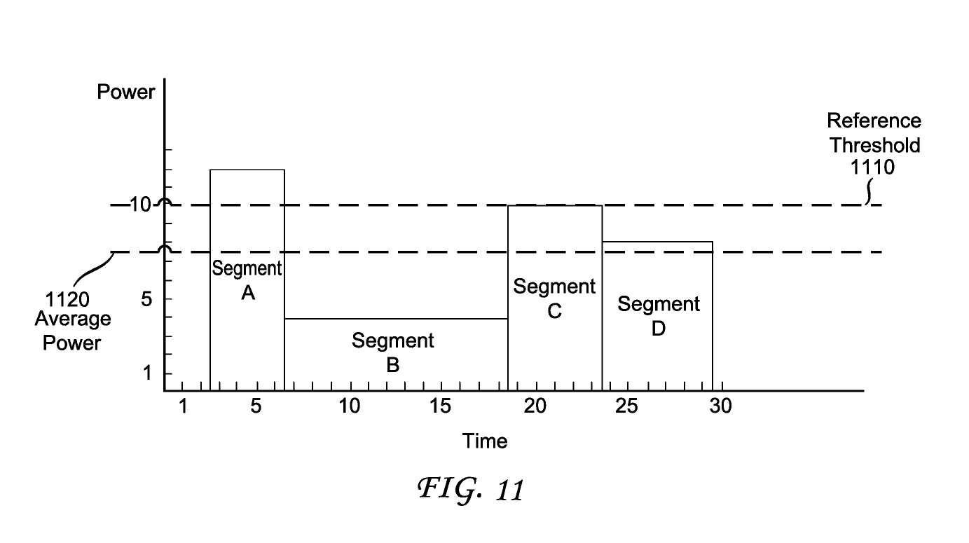

The user may specify that each segment should consume the same power. For example, if the user specifies that each segment should have an average power approximately 48 power units, the adjusted playback time is shown in FIG. 11 as an example, where the time duration for playing back segment A is the same, for segment B is 12, for segment C is 5, and for segment D is 6 time units.

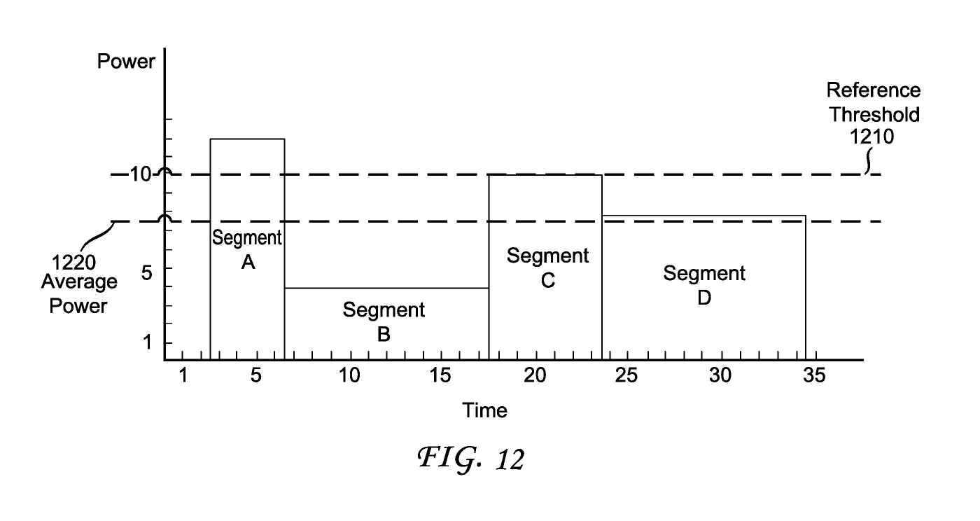

The user may specify that the total power and total duration for playing back the media content. For example, the user may specify that the total power is 240 power units and the total playback time for the media content is 32 time units. FIG. 12 shows one example of the adjusted playback time for each segment. In this case, the processor 352 determines that each segment having its average power lower than the reference power threshold 120, which is the same as the reference power threshold 810, is played back at the maximum duration of 11 time units. The remainder is allocated to segment C whose average power is equal to reference power threshold 1210. Other algorithms can be used as well. For example, the duration of each segment having average power lower than the reference power threshold is inversely proportional to its total power with respect to the total power of all the segments having average power not greater than the reference power threshold in any manner.

In one embodiment, if the user does not specify an additional constraint, the processor 352 is operative and configured to increase the playback time duration for segment B according to the average power of segment B. For example, the adjusted playback time duration for segment B is the current duration of segment B times the reference power divided by the average power of segment B. The playback time duration for segment D can be similarly derived.

It should be noted that if the received version is the original version, segments having higher power consumption should be adjusted for power saving as well.

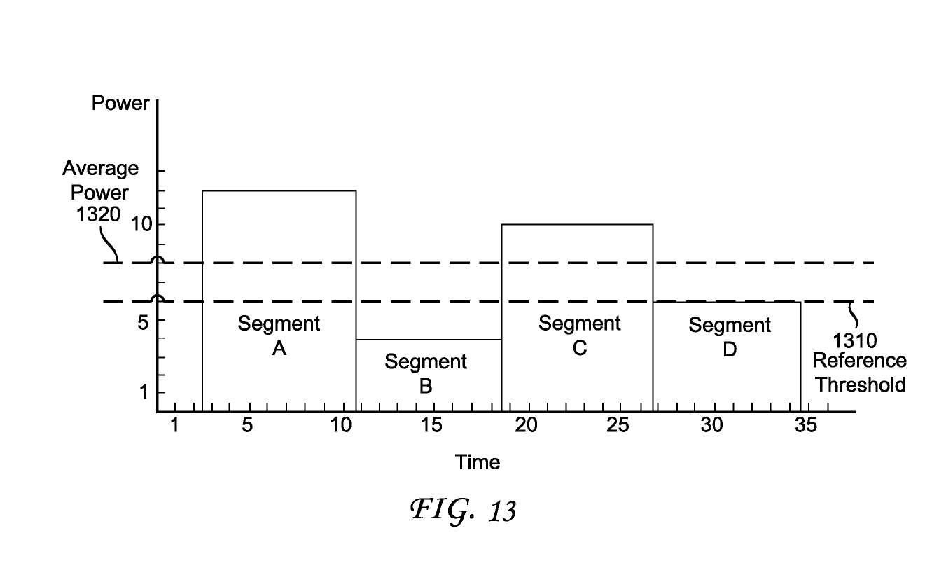

FIG. 13 shows an example of a received completely slowed-down media content having four segments: segments A, B, C, and D. The reference power threshold 1310 is either a default value, a value entered by a user, or a value included in the metadata. The average power 1320 in this example is 8 power units. The average power 1320 can be provided by the server through, for example, metadata. In this example, the reference power is 6 power units, which is smaller than the average power of 8 power units indicating that the user wants to save more power during playback.

As can be seen, each segment illustratively has the same duration, 8 time units, but different average power. Although all segments illustratively have the same duration, the principles can be applied to segments having different durations.

Since the media content received is a completely slowed-down version, in one embodiment, the objective is to speed up those segments having average power over the reference threshold 1310 and not to further slow down those segments having average power equal to or lower than the reference power threshold 1310.

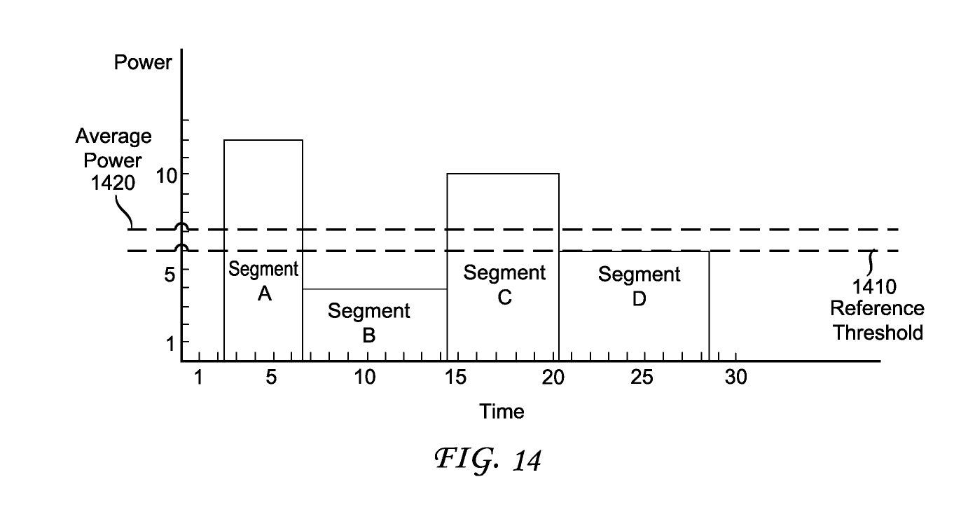

Segment D has the average power equal to the power threshold 1310. As such, the playback time duration is not changed after the adjustment, i.e., the playback number of frames is the same as the number of frames included in segment D. Segment B has an average power lower than the power threshold 1310 and should not be slowed down any further. Segments A and C have average powers larger than the power threshold 1310. As such, the processor 352 determines that the playback time for segments A and C should be reduced. According to an algorithm, the playback time for segments A and C are determined to be 4 time units and 6 time units, respectively, as shown in FIG. 14. The algorithm may be that the reduction in playback is proportional to the reference power 1310 and the difference between the average power of a segment and divided by the reference power 1310, and rounded up to the next integer. Other algorithms similar to those described above with respect to the completely sped-up version can be used as well.

It should be noted that if the received version is the original version, segments having lower power consumption should be adjusted for power saving as well.

In one embodiment, in order not to delay the playback until all segments have been received, the user device 350-1 should obtain metadata indicating the duration and average power consumption of each segment in a media content at the beginning of or before receiving the media content, so that the processor 352 can determine the adjusted playback time for each segment before all segments have been received.

In one embodiment, the processor 352 is operative or configured to manage the buffer for receiving a media content. When the decoding/picture buffer updating frame rate of the received video is decoupled from the presentation frame rate (e.g., raster frame rate) there may be input buffer level issues to consider at the receiver/decoder. The input buffer, for example, is the transport buffer if the received contents are MPEG, H.264, HEVC or other standard encoded. When dealing with live content, the content can only be encoded and delivered as it occurs. In the case of the lower temporal resolution media content mentioned above it must be recognized that there is a form of temporal compression that occurs at the encoding and broadcast side. In other words, considering the 10% speed-up example, it takes 10 frame periods to produce the equivalent of 9 frames of video. This means that every frame of the encoded video represents more than one frame time as captured at the site of the live event. So, even if the video data is delivered to the receiver as soon as possible, the first frame of video cannot be received in one frame time. This suggests that there needs to be a buffering scheme implemented which recognizes that some amount of data must accumulate prior to the start of decode. The buffer level required for start of decoding will be determined by both the buffering rules of the video compression format as well as the level of ‘speed-up’ implemented in the power saving scheme.

Following a channel change, the receiver's input buffer will be empty. The normal acquisition process following channel change requires the decoder to parse the input stream until it finds a random access point at which decoding can begin. In the case of the speed-up mode described above, the decoder will need more time to accumulate data in its input buffer than would be need if decoding an unmodified stream. In order to adapt the decoding process to more quickly reach a level at which sustained decoding can occur (i.e. no buffer underflow), the decoder may choose to start decoding at a slower speed than indicated by the input stream. In other words, if the decoder is required to decrease the decoding frame rate by 10% in order to spread the decoded video over the proper number of frame periods, it may choose instead to decrease the decoding frame rate by 15%. This will slow the rate at which the input buffer is drained, allowing the buffer level to rise to a level at which steady state decoding can begin. At this point the decoder would then revert to a frame rate increase consistent with the difference between the encoded frame rate and the reduced decoding frame rate.

In order to serve the interest of lower power consumption, it should be noted that one of the goals of changing frame rates is to reduce the time duration of high power scenes. In other words one media segment may be encoded with 10% fewer frames than would be expected at a nominal presentation frame rate while another scene might be encoded with 10% more frames than would be expected at a nominal presentation frame rate, which is the presentation frame rate when the original source media content is played back. When decoded and displayed at nominal presentation frame rate, the media segment with 10% fewer frames will occupy less frame time than the time it represents in the original source media content, while the media segment with 10% more frames will occupy more time than it represents in the original media content. It is possible to achieve this same goal at the receiver while delivering media segments encoded at a nominal frame rate, i.e., an original version of the media segment. In this case, metadata associated with the media content segment would guide the playout speed of the video. The metadata may be transmitted separately or with the media content. For portions of the video which represent relatively higher power scenes or images, a frame skipping or frame rate conversion algorithm may be used in order to reduce the number of frames that represent this video portion. Metadata would mark the beginning and end of the higher power segment, as well as the amount of frame reduction necessary in order to achieve the target power reduction. In a similar way, metadata would also mark the beginning and end of lower power video segments. The metadata would also provide an indication of the amount of frame rate expansion needed in order to cause this lower power scene to occupy a larger number of frame times in order to achieve the target power reduction.

Assuming that an original version of a media content is being received, the metadata associated with a media segment may indicate whether the media segment is an average, higher than average, or lower than average power segment. During the higher power media segments, the decoder may decode and update the picture buffer at a rate faster than real-time (normal) rate, which is the presentation frame rate and is the decoding/picture buffer updating rate when the corresponding original version is played back, in order to allow these frames to occupy fewer frame cycles than would be the case for playing back the original version in order to reduce the power consumption of these higher power media segments. As discussed above, the decoder may maintain the decoding/picture updating frame rate but drop/skip some frames to achieve the same purpose.

During the lower power video segments, the decoder may decode or update the picture buffer at a rate slower than the normal rate in order to allow these frames to occupy more frame cycles than would be the case for playing back the original version from which the lower power media segments are respectively derived. As discussed above, the decoder may maintain the decoding/picture updating frame rate but inserting some frames to achieve the same purpose.

These metadata variations in decoding/picture buffer updating speed are not accounted for in the normal decoder buffer parameters dictated by the video and audio compression format in use. As such, the additional input buffer margins needed for this variable decoding speed need to be accounted for at the system level. For example, consider a situation during which there is an extended period of high power media content. A decoder will only be able to drain its input video data buffer at a faster than real-time rate for a short period of time before it experiences a buffer underflow. A similar situation is true for an extended period of low power video content. If the decoder consumes data from its input buffer at a slower than real-time rate for an extended period, the input data, arriving continuously at real-time rate, will soon overflow any input buffer of finite size.

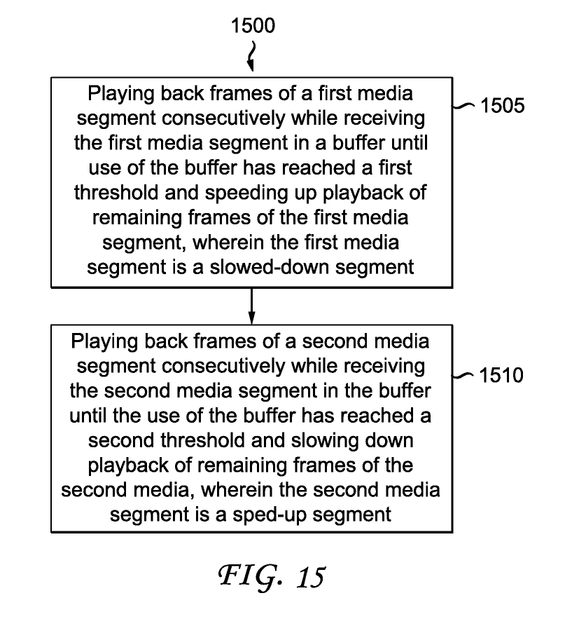

As such, when a media segment is sped up, it is more likely that the input buffer of the user device 350-1 will be emptied faster, i.e., reaching a underflow condition faster, and when a media segment is slowed down, it is more likely that the buffer will be filled up faster i.e., reaching an overflow condition faster. As such, it is necessary to monitor and control the level of use of the input buffer. FIG. 15 shows an illustrative process 1500 performed by the processor 352 of the user device 350-1 to control the use of the input buffer. At step 1505, the processor 352 is operative or configured to play back frames of a first media segment consecutively while receiving the first media segment in a buffer until use of the buffer has reached a first threshold and speeding up playback of remaining frames of the first media segment, wherein the first media segment is a slowed-down segment. At step 1510, the processor 352 is operative or configured to play back frames of a second media segment consecutively while receiving the second media segment in the buffer until the use of the buffer has reached a second threshold and slowing down playback of remaining frames of the second media, wherein the second media segment is a sped-up segment. As described above, the speed-up can be achieved by dropping/skipping some of the remaining frames or increasing the decoding/picture buffer updating rate. It is preferable that the number of frames to be dropped/skipped is the difference between the number of remaining frames and the number of frames that the remaining frames represent if the media segment is not slowed down. For example, if the number of remaining frames is 11 and it was slowed down by 10%, the remaining frames only represents 10 frames if the segment is not slowed down. As such, one frame should be dropped/skipped. In terms of changing the decoding or picture updating rate, the rate should be increased by 10% in this example. This principle applies to playback of all slowed-down segments.

At step 1515, the processor 352 is operative or configured to play back frames of the second media segment consecutively until the use of the buffer (buffer level) has reached a second threshold and slow down playback of remaining frames of the second media segment. As described previously, the slowdown can be achieved by inserting frames into the remaining frames or decreasing the decoding/picture updating rate. It is preferable that the number of frames to be inserted is the difference between the number of frames that the remaining frames represent if the media segment is not sped up and the number of remaining frames. For example, if the number of remaining frames is 9 and it was sped up by 10%, the remaining frames represents 10 frames if the segment is not slowed down. As such, one frame should be inserted. In term of changing the decoding or picture updating rate, the rate should be decreased by 10% in this example. This principle applies to playback of all sped-up segments.

The metadata should indicate the number of frames for each segment in the original version if the media content received is not the original version, so that the processor 352 can determine the degree of speed-up for a sped-up segment and the degree of slowdown for a slowed-down segment with respect to the original version and determine the number of frames that the remaining frames represent in the original version. For example, if there are X frames in a slowed-down segment, Y frames in the original version, and Z remaining frames after the threshold has been reached, the degree of slowdown is P=(X−Y)/Y, the number of frames the Z remaining frames represent is Q=Z*(Y/X). Thus, when the first threshold has been reached, the processor 352 should speed up the playback of the remaining frames by decoding/updating the picture buffer at a rate equal to the normal rate multiplied by (1+P), which is higher than the normal speed, or dropping/skipping Z-Q frames and maintaining the decoding/picture buffer updating rate. Z-Q should be rounded up to an integer, which may be 0 or at least one or more.

Similarly, for a sped-up segment, using the same numbers for the slowed-down example, the degree of speed-up is P=(Y−X)/Y, the number of frames the Z remaining frames represent is Q=Z*(Y/X). Thus, when the second threshold has been reached, the processor 352 should slow down the playback of the remaining frames by decoding/updating the picture buffer at a rate equal to the normal rate multiplied by (1−P), which is slower than the normal speed, or inserting Q-Z frames and maintaining the decoding/picture buffer updating rate. Q-Z should be rounded up to an integer, which may be 0 or at least one or more.

The first and second thresholds can be set locally as defaults or entered and/or changed by the user. If a third media segment immediately following the first media segment is also a slowed-down segment, the processor 352 is operative or configured to play back frames of the third media segment consecutively until the buffer level has reached a third threshold and speed up playback of the remaining frames of the third segment. The third threshold should be higher than the first threshold. Similarly, if a fourth media segment immediately following the second media segment is a sped-up segment, the processor 352 is operative or configured to play back frames of the fourth segment consecutively until the buffer level has reached a fourth level and slow down playback of the remaining frames of the fourth segment. The fourth threshold should be lower than the second threshold. According to the principles of the disclosure, the threshold of a consecutive slowed-down segment is higher than the threshold of the current segment and the threshold of a consecutive sped-up segment is lower than the threshold of the current segment.

In one embodiment, the metadata may indicate the thresholds and the metadata should be received by the receiver preferably before the corresponding media segments have been received. The thresholds could indicate buffer levels in terms of compressed video frames, megabits, seconds, segments, percentage delta from a nominal buffer level, etc. The target thresholds would be expected to change over time as a function of the frequency and duration of high power and low power video segments. In fact, during periods of high power and low power video, the target threshold would be expected to change on a frame-by-frame basis as the input buffer level drains or fills in response to the processor 352 following the metadata directives to play out a media segment at a faster or slower than real-time (normal) rate, which as discussed above is the rate of playing back the corresponding segment in the original version. As such, the target threshold metadata would be updated and sent to the user device 350-1, either in-band or out-of-band, on a regular interval. The update rate of the target threshold metadata would be at least as often as the target buffer level changes, and potentially more often for a broadcast one-way delivery system in order to allow a receiver/decoder to quickly acquire the target threshold metadata following a channel change.

In a broadcast delivery system, the arrival rate of media data at the user device 350-1 is fixed and generally tracks the rate required for real-time playback. As such, in order to modify the level of data in the input buffer, the receiver needs to modify the rate at which it extracts data from the buffer. The receiver will already be responding to metadata that directs it to play faster or slower than real-time in order to achieve a target power savings. However, in order to also achieve and maintain a target buffer level, the receiver will need to consume data from the input buffer at a faster or slower rate than directly indicated by the power savings metadata. The disparity between target buffer level and actual buffer level is likely to be most pronounced immediately following a channel change. After a channel change, the input buffer level is at zero percent. The receiver may choose to modify the decoding rate or the picture buffer updating rate to operate at a decoding and/or picture buffer updating rate slightly below what is recommended by the power savings metadata. Operating at a slower than recommended decoding and picture buffer updating rate will allow, over time, an accumulation of data in the input buffer, eventually reaching the target buffer level. Any reduction in decoding and picture buffer update rate would also be limited by user or system level settings that determine a minimum playout speed. The minimum playout speed would ideally be selected to allow a slower than real-time playout that would operate at a rate that appears substantially equivalent to real-time playback by the average viewer. As discussed previously, reducing the decoding rate/picture buffer updating rate is equivalent to adding frames to a playback segment, because the presentation rate would be higher than the picture buffer updating rate and the same frame in the picture buffer may be displayed more than one time.

Although in the following illustrations, the number of frames in a segment is not modified by the decoder, it is possible to modify the number of frames in a segment and the decoding rate/picture buffer updating rate to either slow down or speed up that segment.

A minimum speed entered by a user may be represented by, for example, frames/second and percentage of slowdown. For example, if the presentation rate is 30 frames/seconds and the user specifies 15 frames/second, the slowdown would be 50%.

The control and monitor of the use of the input buffer is applicable whether the change in frame rate is implemented at the encoder prior to delivery to the receiver/decoder, or implemented by a frame rate conversion algorithm at a receiver/decoder that is receiving unmodified (normal) media data.

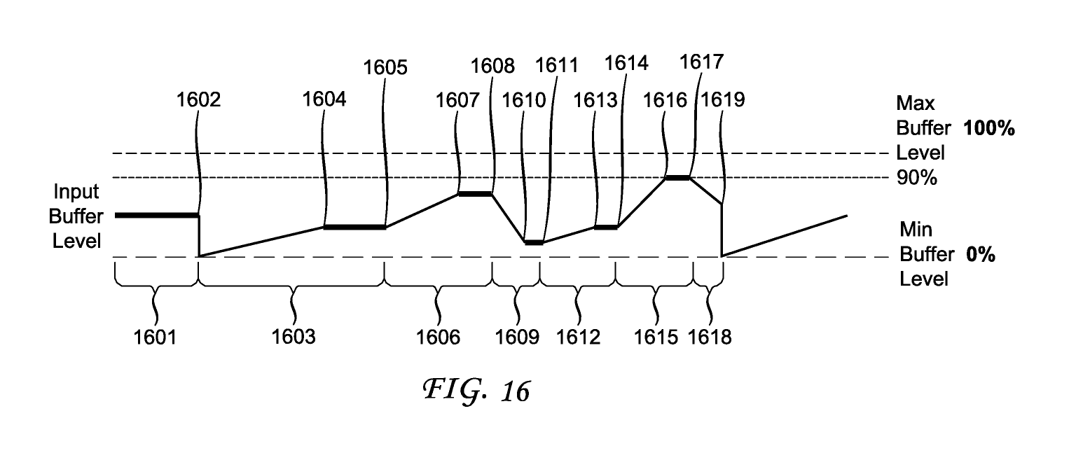

FIG. 16 illustrates buffer level changes over time. The horizontal direction represents the time and the vertical dimension represents the buffer level ranging from 0% to 100%, although FIG. 16 exemplary shows that the maximum use level is 90%. At the interval 1601, the processor 352 is playing back a normal media segment, i.e., at normal speed, and the buffer is maintained at about 50%. At point 1602, the user changes the channel and the processor 352 is operative or configured to clear the buffer. As such, the buffer level is dropped down to 0%. At this point, the processor 352 starts playing back segment 1603, which is a slowed-down segment with 90% playback speed.

Since the play speed is slowed down for segment 1603, the buffer should fill up quickly. The metadata for this segment indicates that when the buffer level has reached 40%, the receiver should play back the remaining frames of the segment at a normal speed. Although illustrating speeding up playback of the remaining frames to the normal speed, any speed-up is sufficient, if the buffer level does not continue to raise. This principle is applicable to playback of any slowed-down segment. To speed up the playback, the processor 352 may skip some frames in the remaining frames. For example, if there are 10 frames left, the processor in this example should skip one frame, which may be the first, fifth, or last frame. In one embodiment, if more than one frame is to be skipped, they should be distributed among the remaining frames to maintain substantially the same temporal resolution. Instead of dropping/skipping frames, the processor 352 may speed up the playback of the remaining frames by increasing decoding and/or updating the picture buffer at a rate that is 10/9 of the presentation frame rate in this example.

At point 1604, the processor 352 detects that the buffer level has reached 40%, plays back the remaining frames of the segment 1603 at a normal speed as described above. As such, the buffer level is maintained at 40% until point 1605, in which the playback of the segment 1303 has ended and the playback of segment 1606 has started. Segment 1606 is a slowed-down segment with a playback speed of 80% and the metadata indicates that the user device should play back this segment at a normal speed when the buffer level has reached 80%.

At point 1607, the processor 352 detects that the buffer level has reached 80%, plays back the remaining frames of the segment 1606 at a normal speed as described above. As such, the buffer level is maintained at 80% until point 1608, in which the playback of the segment 1306 has ended and the playback of segment 1609 has started. Segment 1609 is a sped-up segment with a playback speed of 120% and the metadata indicates that the user device should play back this segment at a normal speed when the buffer level has reached 10%.

At point 1610, the processor 352 detects that the buffer level has reached 10%, plays back the remaining frames of the segment 1309 at a normal speed. In this case, the processor 352 slows down the playback of the remaining frames. Although illustrating slowing down playback of the remaining frames to normal speed, any slowdown is sufficient, if the buffer level does not continue to drop. This principle is applicable to playback of any slowed-down segment. As such, the buffer level is maintained at 10% until point 1611, in which the playback of the segment 1309 has ended and the playback of segment 1612 has started. Segment 1612 is a slowed-down segment with a playback speed of 95% and the metadata indicates that the user device should play back this segment at a normal speed when the buffer level has reached 40%.

At point 1613, the processor 352 detects that the buffer level has reached 40%, plays back the remaining frames of the segment 1312 at a normal speed as described above. As such, the buffer level is maintained at 40% until point 1614, in which the playback of the segment 1612 has ended and the playback of segment 1615 has started. Segment 1615 is a slowed-down segment with a playback speed of 75% and the metadata indicates that the user device should play back this segment at a normal speed when the buffer level has reached 90%.

At point 1616, the processor 352 detects that the buffer level has reached 90%, plays back the remaining frames of the segment 1615 at a normal speed as described above. As such, the buffer level is maintained at 90% until point 1617, in which the playback of the segment 1315 has ended and the playback of segment 1618 has started. Segment 1318 is a sped-up segment with a playback speed of 110% and the metadata indicates that the user device should play back this segment at a normal speed when the buffer level has reached 60%. However, the user changes to another channel at point 1619 before the completion of the playback of segment 1618 and before the buffer level has reached 60%. The processor 352 clears the buffer at point 1619 because of channel change.

A device integrated with or attached to any type of display, such as LCD, LED, OLED, or plasma, can benefit from the power saving effects according to the principles of this disclosure.

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described example, or to carry as data the actual syntax-values written by a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

Numerous specific details have been set forth herein to provide a thorough understanding of the present invention. It will be understood by those skilled in the art, however, that the examples above may be practiced without these specific details. In other instances, well-known operations, components and circuits have not been described in detail so as not to obscure the present invention. It can be appreciated that the specific structural and functional details disclosed herein may be representative and do not necessarily limit the scope of the present invention.

Various examples of the present invention may be implemented using hardware elements, software elements, or a combination of both. Some examples may be implemented, for example, using a computer-readable medium or article which may store an instruction or a set of instructions that, if executed by a machine, may cause the machine to perform a method and/or operations in accordance with the examples. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus and constituents included therein, for example, a processor, an encoder and a decoder, may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing,” intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

1. A method comprising:
receiving media content having first and second media segments;
playing back the first media segment with a first number of frames different from a second number of frames in the first media segment; and
playing back the second media segment, wherein the first number is determined according to average power of the first media segment and average power of the media content.

2. The method of claim 1, wherein the second media segment has a fourth number of frames and playing back the second media segment comprises playing back the second media segment with a third number of frames, and the third number is derived according to average power of the second media segment and the average power of the media content.

3. The method of claim 2, further comprising:
receiving metadata associated with the first and second media segments; and
deriving the first and third numbers from the metadata associated with the first and second media segments, respectively.

4. The method of claim 2, wherein power of a segment is computed according to luminance values of pixels of that segments, and average power of that segment is computed by dividing the power of that segment by a number of frames in that segment.

5. The method of claim 2, wherein the media content is a re-encoded version of an original encoded media content having the first and second segments.

6. The method of claim 2, further comprising:
determining the average power of the first media segment;
if the average power of the first media segment is larger than a threshold, determining the first number as smaller than the second number; and
if the average power of the first media segment is smaller than the threshold, determining the first number is larger than the second number.

7. The method of claim 2, wherein the received media content is a completely slowed-down version and the method further comprises:
if the average power of the second media segment is smaller than a threshold, determining the third number as same as the fourth number, and if the average power of the second media segment is larger than the threshold, determining the third number as smaller than the fourth number.

8. The method of claim 2, wherein the received media content is a completely sped-up version and the method further comprises:
if the average power of the second media segment is larger than the threshold, determining the third number as same as the fourth number, and if the average power of the second media segment is smaller than the threshold, determining the third number as larger than the fourth number.

9. A device comprising:
a memory configured to store a media content; and
a processor configured to receive the media content having first and second media segments; and
play back the first media segment with a first number of frames different from a second number of frames in the first media segment and playback the second media segment, wherein the first number is determined according to average power of the first media segment and average power of the media content.

10. The device of claim 9, wherein the second media segment has a fourth number of frames and playing back the second media segment comprises playing back the second media segment with a third number of frames, and the third number is derived according to average power of the second media segment and the average power of the media content.

11. The device of claim 10, wherein the processor is configured to receive metadata associated with the first and second media segments; and derive the first and third numbers from the metadata associated with the first and second media segments, respectively.

12. The device of claim 10, wherein power of a segment is computed according to luminance values of pixels of that segments, and average power of that segment is computed by dividing the power of that segment by a number of frames in that segment.

13. The device of claim 10, wherein the media content is a re-encoded version of an original encoded media content having the first and second segments.

14. The device of claim 10, wherein the processor is configured to determine the average power of the first media segment; if the average power of the first media segment is larger than a threshold, determine the first number as smaller than the second number; and if the average power of the first media segment is smaller than the threshold, determine the first number is larger than the second number.

15. The device of claim 10, wherein the received media content is a completely slowed-down version; if the average power of the second media segment is smaller than a threshold, the processor is configured to determine the third number as same as the fourth number, and if the average power of the second media segment is larger than the threshold, the processor is configured to determine the third number as smaller than the fourth number.

16. The device of claim 10, wherein the received media content is a completely sped-up version; if the average power of the second media segment is larger than the threshold, the processor is configured to determine the third number as same as the fourth number, and if the average power of the second media segment is smaller than the threshold, the processor is configured to determine the third number as larger than the fourth number.

17. A computer program product stored in non-transitory computer-readable storage media comprising computer-executable instructions for:
receiving media content having first and second media segments;
playing back the first media segment with a first number of frames different from a second number of frames in the first media segment; and
playing back the second media segment, wherein the first number is determined according to average power of the first media segment and average power of the media content.

18. A method comprising:
playing back frames of a first media segment consecutively while receiving the first media segment in a buffer until use of the buffer has reached a first threshold and speeding up playback of remaining frames of the first media segment, wherein the first media segment is a slowed-down segment; and
playing back frames of a second media segment consecutively while receiving the second media segment in the buffer until the use of the buffer has reached a second threshold and slowing down playback of remaining frames of the second media, wherein the second media segment is a sped-up segment.

19. The method of claim 18, wherein speeding up playback of remaining frames of the first media segment comprises one of skipping at least one frame from the remaining frames of the first media segment and speeding up updating a frame in a picture buffer for a display.

20. The method of claim 18, wherein slowing down playback of remaining frames of the second media segment comprises one of inserting at least one frame to the remaining frames of the second media segment and slowing down updating a frame in a picture buffer for a display.

21. The method of claim 18, wherein the media content includes a third media segment immediately following the first media segment and being a slowed-down segment, the method further comprising:
playing back frames of the third media segment consecutively until the use of the buffer has reached a third threshold and speeding up playback of remaining frames of the third media segment, wherein the third threshold is higher than the first threshold.

22. The method of claim 18, wherein the media content includes a fourth media segment immediately following the second media segment and being a sped-up segment, the method further comprising:
playing back frames of the fourth media segment consecutively until the use of the buffer has reached a fourth threshold and slowing down playback of remaining frames of the fourth media segment, wherein the fourth threshold is lower than the second threshold.

23. The method of claim 18, wherein the media content includes a fifth media segment immediately following the second media segment and being a slowed-down segment, the method further comprising:
playing back frames of the fifth media segment consecutively until the use of the buffer has reached the first threshold and speeding up playback of remaining frames of the fifth media segment.

24. The method of claim 18, wherein the media content includes a sixth media segment immediately following the first media segment and being a sped-up segment, the method further comprising:
playing back frames of the sixth media segment consecutively until the use of the buffer has reached the second threshold and slowing down playback of remaining frames of the sixth media segment.

25. The method of claim 18, further comprising receiving the first and second thresholds.

26. The method of claim 18, wherein speeding up the playback of remaining frames of the first media segment speeds up the playback to playback speed of a segment from which the first segment is derived and slowing down playback of remaining frames of the second media slows down the playback to playback speed of a segment from which the second segment is derived.

27. A device comprising:
a memory configured to store a media content;
a processor configured to play back frames of a first media segment consecutively while receiving the first media segment in a buffer until use of the buffer has reached a first threshold and speeding up playback of remaining frames of the first media segment, wherein the first media segment is a slowed-down segment; and play back frames of a second media segment consecutively while receiving the second media segment in the buffer until the use of the buffer has reached a second threshold and slowing down playback of remaining frames of the second media, wherein the second media segment is a sped-up segment.

28. The device of claim 26, wherein the processor is configured to speed up playback of remaining frames of the first media segment by one of skipping at least one frame from the remaining frames of the first media segment and speeding up updating a frame in a picture buffer for a display.

29. The device of claim 26, wherein the processor is configured to slow down playback of remaining frames of the second media by one of inserting at least one frame to the remaining frames of the second media segment and slowing down updating a frame in a picture buffer for a display.

30. The device of claim 26, wherein the media content includes a third media segment immediately following the first media segment and being a slowed-down segment, wherein the processor is configured to play back frames of the third media segment consecutively until the use of the buffer has reached a third threshold and speed up playback of remaining frames of the third media segment, wherein the third threshold is higher than the first threshold.

31. The device of claim 26, wherein the media content includes a fourth media segment immediately following the second media segment and being a sped-up segment, wherein the processor is configured to play back frames of the fourth media segment consecutively until the use of the buffer has reached a fourth threshold and slow down playback of remaining frames of the fourth media segment, wherein the fourth threshold is lower than the second threshold.

32. The device of claim 26, wherein the media content includes a fifth media segment immediately following the second media segment and being a slowed-down segment, wherein the processor is configured to play back frames of the fifth media segment consecutively until the use of the buffer has reached the first threshold and speed up playback of remaining frames of the fifth media segment.

33. The device of claim 26, wherein the media content includes a sixth media segment immediately following the first media segment and being a sped-up segment, wherein the processor is configured to play back frames of the sixth media segment consecutively until the use of the buffer has reached the second threshold and slowing down playback of remaining frames of the sixth media segment.

34. The device of claim 8, wherein the processor is configured to receive the first and second thresholds.

35. The device of claim 26, wherein the processor is configured to speed up playback of remaining frames of the first media segment by speeding up the playback to playback speed of a segment from which the first segment is derived, and slow down playback of remaining frames of the second media by slowing down the playback to playback speed of a segment from which the second segment is derived.

36. A computer program product stored in non-transitory computer-readable storage media comprising computer-executable instructions for:
playing back frames of a first media segment consecutively while receiving the first media segment in a buffer until use of the buffer has reached a first threshold and speeding up playback of remaining frames of the first media segment, wherein the first media segment is a slowed-down segment; and
playing back frames of a second media segment consecutively while receiving the second media segment in the buffer until the use of the buffer has reached a second threshold and slowing down playback of remaining frames of the second media, wherein the second media segment is a sped-up segment.
